(19) United States
(12) Patent Application Publication
(10) Pub. No.: US 2022/0001328 A1
(43) Pub. Date: Jan. 6, 2022

(54) ENERGY-SAVING AIR DRYER, AND METHOD FOR PRODUCING DRY AIR USING THE SAME

(71) Applicant: KOREA RESEARCH INSTITUTE OF CHEMICAL TECHNOLOGY, Daejeon (KR)

(72) Inventors: Ji Woong YOON, Daejeon (KR); Jong-San CHANG, Daejeon (KR); U Hwang LEE, Daejeon (KR); Young Kyu HWANG, Daejeon (KR); Kyung Ho CHO, Daejeon (KR)

(21) Appl. No.: 17/281,904

(22) PCT Filed: Oct. 25, 2019
(86) PCT No.: PCT/KR2019/014171

§ 371 Date: Mar. 31, 2021

(30) Foreign Application Priority Data
Oct. 29, 2018 (KR) 10-2018-0129734
Mar. 20, 2019 (KR) 10-2019-0031757

(51) Int. Cl. B01D 53/26; B01D 46/00; B01D 53/04

(52) U.S. Cl. CPC B01D 53/261; B01D 46/0095; B01D 2259/4009; B01D 2257/80; B01D 53/04

(57) ABSTRACT

The present invention provides an energy-saving air dryer comprising: a compressor for compressing the air in the atmosphere to form compressed air; a heat exchanger which is disposed on one side of the compressor and recovers compression heat from the compressed air; a pre-filter which is disposed on one side of the heat exchanger and removes pollutants from the compressed air; a pair of adsorption towers which communicate with the pre-filter and are filled with an adsorbent, wherein dry air is formed when compressed air flows into the adsorption towers according to the opening and closing of a valve and moisture is adsorbed, or moisture is desorbed from the adsorbent when dry air retaining the compression heat recovered in the heat exchanger is transferred to the adsorption towers; and an after filter which extends from the one side of the adsorption towers and removes pollutants from the dry air from which moisture has been removed.

### BACKGROUND OF THE INVENTION

### Field of the Invention

The present invention relates to an air dryer for producing dry air by saving energy, and a method for producing dry air by removing moisture from the air in the atmosphere containing moisture by using the same.

### Description of the Related Art

The air in the atmosphere always contains moisture or water vapor, and the compressed air used by compressing the air in the atmosphere in industrial sites may contain contaminants including moisture because the air in the atmosphere is compressed as it is.

In this case, the contaminants cause corrosion of an air line supplying compressed air and outflow of air, and lower the power and efficiency of an air tool. In addition, the maintenance cost of the air line is greatly increased by removing a lubricant from the air line or generating a solid.

Since the moisture and contaminants in the compressed air are removed through a process of separating the moisture and contaminants from the air sucked into an air compressor by a filter having a simple structure and the like, the compressed air is used for various pneumatic devices or for various purposes.

Since the moisture in the compressed air is separated into a liquid state through the separation process by the simple structure filter, etc., the efficiency of the compressed air decreases when the moisture accumulates in the filter according to use, and as a result, the compressed air from which the moisture is not removed well is supplied.

When the compressed air from which the moisture is not sufficiently removed as described above is used in industrial sites, etc., the compressed air causes a failure of the devices used as well as various industrial devices, and particularly, in a workplace where a precise work is required, a problem of its use becomes more serious.

Therefore, in various industrial sites, dry air from which moisture and contaminants have been removed using an air dryer device is produced and supplied.

The air dryer includes a refrigeration air dryer which condenses the moisture contained in the air by reducing the temperature of the air to discharge the moisture, and an adsorption dryer that forcibly dehumidifies the moisture contained in the compressed air by passing through a tower filled with an adsorbent.

Since the adsorption dryer removes the moisture and the contaminants while alternately drying the air by a plurality of adsorbents compared with using a simple filter, the removal of the moisture and the contaminants is very excellent, but the moisture in the compressed air is separated into a liquid by the adsorbent. As a result, an efficiency problem is still inherent due to the accumulation of moisture, and in order to minimize this problem, the plurality of towers needs to be frequently alternated.

In Korean Patent Registration No. 1774862 (Patent Document 1), disclosed is a control method of an air dryer that prevents the pressure of dry air supplied to a place of use from dropping, when the dehumidification or regeneration of a first tank side is completed and the function is switched to the regeneration or dehumidification of a second tank side. However, a technology for controlling an air flow of the air dryer is disclosed, but an air dryer by selecting a renewable adsorbent is not configured.

Therefore, it is very necessary to develop a device for producing dry air and a method for producing dry air using the same by reducing process cost by an air dryer with increased adsorbent use efficiency and a method of producing dry air using the same, wherein a metal-organic structure is selected as a new moisture adsorbent to enable regeneration at a low temperature.

As prior arts related to this, there are a method for controlling an air dryer disclosed in Korean Patent Registration No. 1774862 (issued date: Aug. 30, 2017) (Patent Document 1) and a method for producing dry air disclosed in Korean Patent Registration No. 0147313 (published date: Jul. 18, 1996) (Patent Document 2).

The above-described technical configuration is the background art for assisting the understanding of the present invention, and does not mean a conventional technology widely known in the art to which the present invention belongs.

### SUMMARY OF THE INVENTION

Therefore, an object of the present invention is to provide a device for producing dry air and a method for producing dry air using the same capable of reducing process costs by producing dry air by an air dryer including an adsorption tower filled with a moisture adsorbent, filling a renewable adsorbent in the adsorption tower by desorbing moisture at a low temperature, and desorbing and regenerating the moisture adsorbed on the adsorbent by using low-temperature compression heat generated while compressing the air in the atmosphere.

The objects to be solved by the present disclosure are not limited to the aforementioned object(s), and other object(s), which are not mentioned above, will be apparent to those skilled in the art from the following description.

To solve the problems, an embodiment of the present invention provides an energy-saving air dryer comprising:

a compressor that compresses the air in the atmosphere to form compressed air;

a heat exchanger that is disposed on one side of the compressor and recovers the compression heat of the compressed air;

a pre-filter that is disposed on one side of the heat exchanger and removes contaminants from the compressed air;

a pair of adsorption towers which communicates with the pre-filter, and is filled with an adsorbent to adsorb moisture when the compressed air flows into by the opening and closing of valves to form dry air or receives dry air having compression heat recovered from the heat exchanger to desorb the moisture of the adsorbent; and

an after filter that extends from one side of the adsorption tower to remove contaminants from dry air from which moisture has been removed.

The adsorbent may have a moisture adsorption amount of 10 wt % or more to the weight of the adsorbent in a region of 10% relative humidity (P/P₀≤0.1) or less in the adsorption isotherm, and in which the adsorbed moisture of the adsorbent in the adsorption step is regenerated to dry air of 100° C. or less.

The adsorbent may be a metal trimesate-based metal-organic framework, a metal terephthalate-based metal-organic structure or silicoaluminophosphate-based zeolite.

Some of the dry air generated in the adsorption tower may be recovered by the heat exchanger and heated by heat exchange with the compressed air having compression heat.

Another embodiment of the present invention provides an energy-saving air dryer comprising:

a compressor that compresses the air in the atmosphere to form compressed air;

a heat exchanger that is disposed on one side of the compressor and recovers the compression heat of the compressed air;

a pre-filter that is disposed on one side of the heat exchanger and removes impurities from the compressed air;

a cooling dryer that is disposed around the pre-filter and configured to discharge condensed water by condensing moisture in the compressed air by cooling the compressed air by introducing a coolant to one side;

a pair of adsorption towers which is connected to the cooling dryer, and is filled with an adsorbent to adsorb moisture when the compressed air flows into by the opening and closing of valves to form dry air or receives dry air having compression heat recovered from the heat exchanger to desorb the moisture of the adsorbent; and

an after filter that extends from one side of the adsorption tower to remove contaminants from dry air from which moisture has been removed.

The adsorbent may have a moisture adsorption amount of 10 wt % or more to the weight of the adsorbent in a region of 10% relative humidity (P/P₀≤0.1) or less in the adsorption isotherm, and in which the adsorbed moisture of the adsorbent in the adsorption step is regenerated to dry air of 100° C. or less.

The adsorbent may be a metal trimesate-based metal-organic framework, a metal terephthalate-based metal-organic structure or silicoaluminophosphate-based zeolite.

The heat exchanger may recover the compression heat generated in the process of forming compressed air by compressing the air in the atmosphere by the compressor and transfer the compression heat to the dry air.

Some of the dry air generated in the adsorption tower may be recovered by the heat exchanger and heated by heat exchange with the compressed air having compression heat.

The cooling dryer may be introduced with a coolant to one side to cool the dry air to 4 to 6° C., and to collect and discharge moisture in the dry air as condensed water.

The adsorption tower may absorb 1 to 30 wt % of moisture to the total moisture adsorption amount in the introduced compressed air to discharge dry air.

Another aspect of the present invention provides a method for producing dry air comprising: forming compressed air by compressing the air in the atmosphere (step 1);

preliminary-cooling the compressed air by heat exchange (step 2);

introducing the compressed air into a cooling dryer and forming and discharging condensed water by exchanging heat with a coolant to remove some moisture from the compressed air (step 3);

producing dry air by contacting the compressed air from which some of the moisture has been removed with an adsorbent (step 4);

heating the dry air by bypassing some of the dry air and exchanging heat with compressed air having compression heat (step 5); and

desorbing moisture by contacting the heated dry air with the adsorbent to which moisture has been adsorbed (step 6).

The adsorbent may have a moisture adsorption amount of 10 wt % or more to the weight of the adsorbent in a region of 10% relative humidity (P/P₀≤0.1) or less in the adsorption isotherm, and is a metal trimesate-based metal-organic framework, a metal terephthalate-based metal-organic structure or silicoaluminophosphate-based zeolite, in which the adsorbed moisture of the adsorbent in the adsorption step is regenerated to dry air of 100° C. or less.

Yet another embodiment of the present invention provides an energy-saving air dryer comprising:

a compressor that compresses the air in the atmosphere to form compressed air;

a heat exchanger that is disposed on one side of the compressor and recovers the compression heat of the compressed air;

a pre-filter that is disposed on one side of the heat exchanger and removes impurities from the compressed air;

a first adsorption tower that is disposed on one side of the pre-filter and filled with a first adsorbent and introduces compressed air by opening and closing of valves and adsorbs moisture in the compressed air to produce dry air; and

a second adsorption tower that is disposed on one side of the first adsorption tower, filled with a second adsorbent and introduces dry air discharged from the first adsorption tower, absorbs moisture remaining in the dry air.

The first adsorbent may have a moisture adsorption amount of 30 wt % or more to the weight of the adsorbent in a region with a relative humidity of 5 to 40% (0.05≤P/P₀≤0.5) in the adsorption isotherm, and be regenerable to dry air at less than 100° C.

The second adsorbent may have a moisture adsorption amount of 10 wt % or more to the weight of the adsorbent in a region of 10% relative humidity (P/P₀≤0.1) or less in the adsorption isotherm.

The first adsorption tower and the second adsorption tower may be arranged in series through a first dry air introduction path.

One side of the first adsorption tower may be provided with a first dry air discharge valve, and discharges dry air having a dew point of 2° C. to 10° C. through the first dry air discharge valve.

Some of the dry air produced in the first or second adsorption tower may be branched and introduced into the heat exchanger, heated by heat exchange with the compression heat and recovered to one side of the first or second adsorption tower, and desorbs moisture adsorbed on the adsorbent by heating the first or second adsorbent.

The compression heat may be maintained below 100° C., the compression heat may heat the dry air introduced into the heat exchanger, and the heated dry air may flow into one side of the first adsorption tower to desorb moisture adsorbed on the first adsorbent and regenerate the first adsorbent.

Some of the dry air produced in the second adsorption tower may be branched and recovered by the heat exchanger, and the dry air may be heated by heat exchange in the heat exchanger, reheated through a heater provided at one side of the heat exchanger, and introduced to the one side of the second adsorption tower to regenerate the second adsorbent.

Yet another aspect of the present invention provides a method for producing dry air comprising:

forming compressed air by compressing the air in the atmosphere (step a):

introducing the compressed air into the first adsorption tower to adsorb some of the moisture in the compressed air to produce dry air (step b);

discharging and supplying the dry air to one side, or determining whether to remove residual moisture in the dry air (step c);

introducing the dry air into the second adsorption tower to absorb residual moisture in the dry air to produce and discharge dry air (step d);

branching some of the dry air in step 2 and heat-exchanging with compressed air having compressed heat to heat the dry air (step e);

introducing the dry air heated to less than 100° C. into the first adsorption tower to regenerate the first adsorbent filled in the first adsorption tower (step f); and

branching the dry air heated in step d and forming dry air of 100 to 200° C. by heating with a heater, and introducing the formed dry air into the second adsorption tower to regenerate the second adsorbent (step g).

The first adsorbent may have a moisture adsorption amount of 30 wt % or more to the weight of the adsorbent in a region with a relative humidity of 5 to 40% (0.05≤P/P₀≤0.5) in the adsorption isotherm, and be regenerable to dry air at less than 100° C.

The second adsorbent may have a moisture adsorption amount of 10 wt % or more to the weight of the adsorbent in a region of 10% relative humidity (P/P₀≤0.1) or less in the adsorption isotherm and be regenerable to dry air at less than 100° C. to 200° C. or less.

In step b, the produced dry air with a dew point of 2 to 10° C. may be discharged to one side.

In step d, dry air with a dew point of −40° C. or less may be supplied.

According to the present invention, compressed air is supplied to an adsorption tower filled with a metal organic structure or an adsorbent following a Langmuir-type adsorption isotherm capable of regeneration by desorption of moisture at a low temperature due to a high moisture adsorption amount and low adsorption energy with moisture and the moisture is desorbed to produce high-quality dry air with a moisture content of a dew point of −40° C. or less under pressure.

In addition, condensed water is formed by preliminary heat exchange through a heat exchanger and main heat exchange with a coolant through a cooling dryer, so that some of the moisture in compressed air is removed by more than 90 wt % of the total moisture content before flowing into the adsorption tower and then flows into the adsorption tower, so that the moisture adsorption load of the adsorption tower can be reduced to increase the production efficiency of overall dry air.

In addition, the dry air is heated to 100° C. or less by heat exchange with compression heat of 80 to 100° C. generated in the process of forming the compressed air by bypassing some of the generated dry air, the heated dry air is introduced from the adsorption tower and the adsorbent is regenerated by using the low-temperature compression heat that is lost by desorption of the adsorbent, so that the use of energy required for dry air production can be reduced.

Since the adsorption energy with moisture is low, compressed air is introduced into the plurality of adsorption towers filled with a metal-organic structure or a silicon-aluminophosphate-based adsorbent that can be regenerated by desorption of moisture at low temperatures, and the moisture is adsorbed, so that high-quality dry air having a moisture content of 2 to 10° C. or less can be selectively produced.

In addition, since the adsorbent may be effectively regenerated by using the compression heat generated in the process of producing compressed air, it is possible to effectively save energy and produce dry air.

In addition, it is possible to significantly reduce the amount of dry air used for regeneration of the adsorbent in the process of producing high-purity dry air by recovering some of the produced dry air to regenerate the adsorbent.

In addition, the adsorbent, which is a metal-organic structure, can be regenerated in a non-heating manner to maintain the strength of the adsorbent and enables long-term regeneration and use of the adsorbent.

In addition, a plurality of adsorption towers are arranged in series, and the rear adsorption tower is filled with a Langmuir-type adsorbent with very strong hydrophilicity to effectively adsorb the remaining moisture in the dry air from which certain moisture has been removed through the front adsorption tower, thereby reducing high-quality dry air. In addition, it is possible to supply low-quality dry air according to the requirements of dry air, or to selectively produce and supply high-quality dry air required by semiconductor processes and pneumatic equipment, thereby greatly increasing energy efficiency.

It should be understood that the effects of the present invention are not limited to the effects, but include all effects that can be deduced from the detailed description of the present invention or configurations of the present invention described in appended claims.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a process diagram illustrating a configuration of an energy-saving air dryer according to an embodiment of the present invention;

FIG. 2 is an adsorption isotherm according to a type of adsorbent filled in an adsorption tower in the energy-saving air dryer according to an embodiment of the present invention;

FIG. 3 is a process diagram illustrating a configuration of an energy-saving air dryer according to another embodiment of the present invention;

FIG. 4 is a process diagram illustrating a flow of compressed air when an adsorption process is performed in the energy-saving air dryer according to another embodiment of the present invention.

FIG. 5 is a process diagram illustrating a flow of dry air when a desorption process is performed in the energy-saving air dryer according to another embodiment of the present invention;

FIG. 6 is a process flowchart illustrating a procedure of a method for producing dry air through the energy-saving air dryer according to another embodiment of the present invention;

FIG. 7 is a moisture breakthrough curve according to a type of adsorbent according to an embodiment of the present invention;

FIG. 8 is a curve showing a dry air production cycle for a conventional commercial adsorbent (molecular sieve+silica gel);

FIG. 9 is a curve showing a dry air production cycle for an MIL-100Fe adsorbent according to an embodiment of the present invention;

FIG. 10 is a process diagram illustrating a configuration of an energy-saving air dryer according to yet another embodiment of the present invention;

FIG. 11 is a process diagram illustrating a flow of compressed air when an adsorption process in a first adsorption tower is performed in the energy-saving air dryer according to yet another embodiment of the present invention;

FIG. 12 is a process diagram illustrating a flow of dry air when a desorption process in the first adsorption tower is performed in the energy-saving air dryer according to yet another embodiment of the present invention;

FIG. 13 is a process diagram illustrating a flow of compressed air when an adsorption process in a second adsorption tower is performed in the energy-saving air dryer according to yet another embodiment of the present invention;

FIG. 14 is a process diagram illustrating a flow of dry air when a desorption process in the second adsorption tower is performed in the energy-saving air dryer according to yet another embodiment of the present invention; and

FIG. 15 is a process flowchart illustrating a procedure of a method for producing dry air using an energy-saving air dryer according to yet another embodiment of the present invention.

### DETAILED DESCRIPTION OF THE PREFERRED EMBODIMENT

To solve the problems, while thinking about a method of producing dry air using a renewable adsorbent by desorption of moisture at a lower temperature below 100° C., the present inventors have completed an energy-saving air dryer capable of adsorbing and desorbing moisture at a low temperature of 100° C. or less by regenerating an adsorbent by selecting an adsorbent having a moisture adsorption amount of 10 wt % or more relative to the weight of the adsorbent in the range of 10% relative humidity (P/P₀≤0.1) or less in an adsorption isotherm and capable of regenerating the moisture adsorbed on the adsorbent in the adsorption step with dry air of 100° C. or less and recovering compression heat generated and lost when compressed air is formed. In addition, the present inventors have found that high-quality dry air having a moisture content of −40° C. or less may be produced in large quantities by saving energy very much by using the energy-saving air dryer and completed the present invention.

In addition, the present inventors found that the dry air with reduced moisture content may be produced and supplied by filling the adsorption tower with an adsorbent which exhibited sigmoid type adsorption behavior in the adsorption isotherm when the adsorption amount rapidly increased according to the relative vapor pressure in a region of 5% to 40% of relative humidity (0.05≤P/P₀≤0.5) in the adsorption isotherm, had the moisture adsorption of 30 wt % or more to the weight of the adsorbent, and desorbed moisture adsorbed on the adsorbent by recovering the compression heat generated and lost during the production of compressed air.

In addition, the present inventors found that when high-quality dry air with a further reduced moisture content is required, an adsorption tower filled with an adsorbent, which has very strong hydrophilicity and exhibits Langmuir type adsorption behavior in the adsorption isotherm, is additionally disposed to produce and selectively supply high-quality dry air having a dew point of −40° C. or less by introducing dry air with controlled moisture again and the present invention has been completed.

Hereinafter, preferred embodiments of the present invention will be described in detail with reference to the accompanying drawings.

Before describing the present invention in detail, terms or words used in this specification should not be construed as unconditionally limited to a conventional or dictionary meaning, and the inventors of the present invention can appropriately define and use the concept of various terms in order to describe their invention in the best method. Furthermore, it should be understood that these terms or words should be interpreted as meanings and concepts consistent with the technical idea of the present invention.

That is, the terms used in this specification are only used to describe a preferred embodiment of the present invention, and are not intended to specifically limit the contents of the present invention, and it should be noted that these terms are terms defined in consideration with various possibilities of the present invention.

In addition, in this specification, it should be understood that the singular expression may include a plural expression unless clearly indicated in another meaning in the context, and even if similarly expressed in the plural, the singular expression may include the meaning of the singular number.

Throughout this specification, when a component is described as “including” another component, the component does not exclude any another component, but further includes any another component unless otherwise indicated.

Further, hereinafter, in the following description of the present invention, a detailed description of a configuration determined to unnecessarily obscure the subject matter of the present invention, for example, a known technology including the prior art may be omitted.

While studying a method for producing dry air, the present inventors found that a conventional air dryer using a molecular sieve mixture (molecular sieve+silica gel), activated alumina or silica gel adsorbent has very high adsorption performance of moisture in the compressed air, but has a high regeneration temperature of 150 to 180° C. in a process for regenerating an adsorbent to cause a problem that a large amount of energy is consumed during regeneration.

To solve the problems, while thinking about a method of producing dry air using a renewable adsorbent by desorption of moisture at a lower temperature of 100° C. or less, the present inventors have completed an energy-saving air dryer capable of adsorbing and desorbing moisture at a low temperature of 100° C. or less by regenerating an adsorbent by selecting an adsorbent having a moisture adsorption amount of 10 wt % or more relative to the weight of the adsorbent in the range of 10% relative humidity (P/P₀≤0.1) or less in an adsorption isotherm and capable of regenerating the moisture adsorbed on the adsorbent in the adsorption step with dry air of 100° C. or less and recovering compression heat generated and lost when compressed air is formed. In addition, the present inventors have found that high-quality dry air having a moisture content of −40° C. or less may be produced in large quantities by saving energy very much by using the energy-saving air dryer and completed the present invention.

Meanwhile, the present inventors found that the dry air with reduced moisture content may be produced and supplied by filling the adsorption tower with an adsorbent which exhibited sigmoid type adsorption behavior in the adsorption isotherm when the adsorption amount rapidly increased according to the relative vapor pressure in a region of 5% to 40% of relative humidity (0.05≤P/P₀≤0.5) in the adsorption isotherm, had the moisture adsorption of 30 wt % or more to the weight of the adsorbent, and desorbed moisture adsorbed on the adsorbent by recovering the compression heat generated and lost during the production of compressed air.

In addition, the present inventors found that when high-quality dry air with a further reduced moisture content is required, an adsorption tower filled with an adsorbent, which has very strong hydrophilicity and exhibits Langmuir type adsorption behavior in the adsorption isotherm, is additionally disposed to produce and selectively supply high-quality dry air having a dew point of −40° C. or less by introducing dry air with controlled moisture again and completed the present invention.

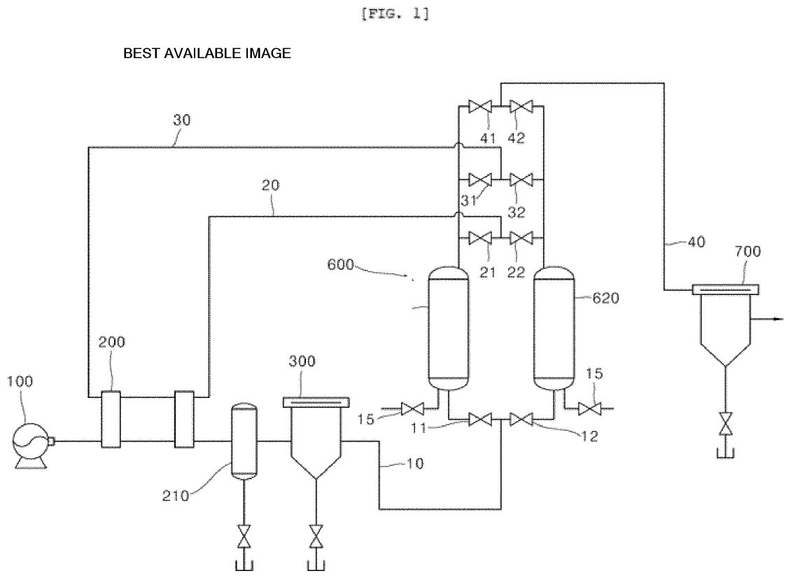

FIG. 1 is a process diagram illustrating a configuration of an energy-saving air dryer according to an embodiment of the present invention.

Referring to FIG. 1, an energy-saving air dryer according to an embodiment of the present invention includes a compressor 100, a heat exchanger 200, a pre-filter 300, an adsorption tower 600, and an after filter 700.

Hereinafter, a compressed air path 10, a dry air introduction path 20, a heated dry air introduction path 30, and a dry air outlet path 40 provide pipelines through which compressed air, dry air, heated dry air, and dry air as a final product flow, respectively. A first adsorption inflow selection valve 11, a second adsorption inflow selection valve 12, a first adsorption outflow selection valve 21, a second adsorption outflow selection valve 22, a purge discharge valve, a first regeneration selection valve 31, a second regeneration selection valve 32, a first dry air outflow selection valve 41 and a second dry air outflow selection valve 42 are provided at ends of the pipelines and controlled by a controller (not illustrated).

The compressor 100 compresses the air in the atmosphere to form compressed air.

While the compressor 100 compresses the air in the atmosphere, compression heat may be issued, and the compression heat may be recovered by heat exchange.

By compression of the compressor 100, the compressed air is heated to 80 to 100° C. due to compression heat.

The compressed air compressed by the compressor 100 is introduced into the heat exchanger 200.

The heat exchanger 200 is disposed on one side of the compressor 100 and recovers the compression heat of the compressed air.

If the compression heat is not recovered, the compression heat is lost as waste heat, but when preliminary heat exchange with dry air introduced to one side using the heat exchanger 200 is performed, the compression heat may be usefully used to heat the dry air.

At this time, the compressed air is cooled to a room temperature of 20 to 30° C., and the moisture in the compressed air is condensed by cooling to generate condensed water.

A separator 210 is disposed on one side of the heat exchanger 200 and may collect and discharge the condensed water generated by cooling of the compressed air.

The pre-filter 300 is disposed on one side of the heat exchanger 200 and removes contaminants from the compressed air.

The contaminants removed by the pre-filter 300 may have an average particle size larger than that of water vapor.

When the air in the atmosphere is compressed, the moisture content is increased, and contaminants such as dust and oil in the air in the atmosphere are also increased. Therefore, the contaminants are removed by using the pre-filter 300 to produce high-quality compressed air.

The first regeneration selection valve 31 and the second regeneration selection valve 32 are provided at the ends of the heated dry air introduction path 30, and the heated dry air may be introduced selectively to a second adsorption tower 620 of a pair of adsorption towers 600 to which the heated air dry is introduced.

The compressed air flows into the adsorption tower 600 along the compressed air path 10 by passing through the pre-filter 300.

The adsorption tower 600 is provided in a pair to communicate with the pre-filter 300, and filled with an adsorbent to adsorb moisture when the compressed air flows into the one side along the opening and closing of the first adsorption inflow selection valve 11 and the second adsorption inflow selection valve 12 to form dry air or receives dry air having compression heat recovered from the heat exchanger 200 to desorb the moisture of the adsorbent filled therein.

At the end of the compressed air 10, the first adsorption inflow selection valve 11 and the second adsorption inflow selection valve 12 are installed.

Compressed air from which the first adsorption inflow selection valve 11 and the second adsorption inflow selection valve 12 are provided and condensed to remove some moisture may selectively flow into one side of the pair of adsorption towers 600.

The adsorption tower 600 is filled with an adsorbent which has a moisture adsorption amount of 10 wt % or more to the weight of the adsorbent in a region of 10% relative humidity (P/P₀≤0.1) or less in the adsorption isotherm, and in which the adsorbed moisture of the adsorbent in the adsorption step is regenerated to dry air of 100° C. or less.

Specifically, the adsorbent may be a metal trimesate-based metal-organic framework (hereinafter referred to as ‘MOF’), a metal terephthalate-based metal-organic structure or silicoaluminophosphate-based zeolite.

The MOF is a porous coordination polymer compound and has a crystalline skeleton, and a cluster of metal ions and an organic ligand are coordinated to form a skeleton.

The MOF has a specific surface area that is 3 to 5 times wider than that of silica gel or zeolite, and accordingly, has the adsorption amount of moisture of 2 to 4 times more, so that the MOF can be used as a moisture adsorbent. When using the MOF as an adsorbent in the adsorption tower 600 of the air dryer, the specific surface area increases to exhibit a high moisture adsorption amount, and very effective desorption is enabled even at low temperatures.

The MOF is preferable because moisture adsorbed by the adsorbent can be desorbed even by recovering only the compression heat generated when generating the compressed air.

Specifically, the MOF may be metal trimesate-based MIL-100X (X=any one of metals consisting of Fe, Cr, Al and V) and its derivatives, and metal terephthalate-based MIL-101X (X=any one of metals consisting of Cr, Fe and Al) and derivatives thereof.

In the present invention, the adsorbent may be MIL-100Fe, MIL-101Cr, or SAPO-34 having a moisture adsorption amount of 10 wt % or more to the weight of the adsorbent in a region of 10% relative humidity (P/P₀≤0.1) or less.

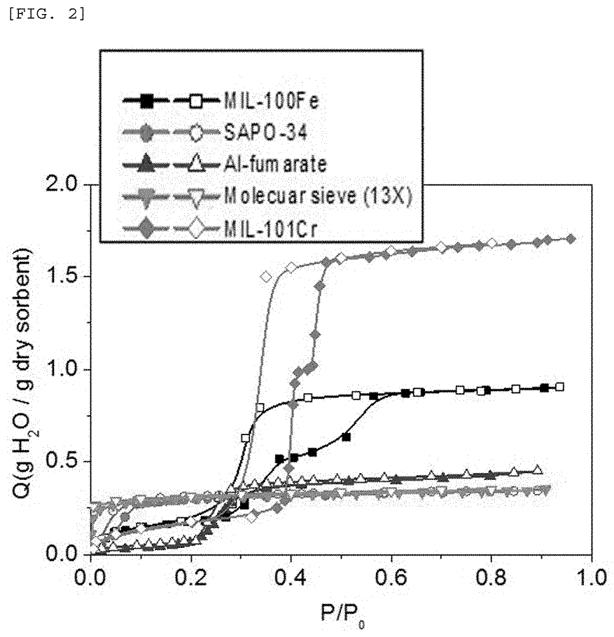

FIG. 2 is an adsorption isotherm according to an adsorbent filled in an adsorption tower in the energy-saving air dryer according to an embodiment of the present invention.

Referring to FIG. 2, MIL-100Fe and SAPO-34 according to an embodiment of the present invention represent Langmuir-type moisture adsorption isotherms at a relative pressure (P/P₀) of 0.3 or less, and also very easily desorb the moisture at a low temperature by desorbing more than 90% of the adsorbed moisture at a relative humidity near 0.

On the other hand, it can be seen that a commercial adsorbent desorbs the moisture to 30% of less at the relative humidity near 0.

Accordingly, the adsorbent according to an embodiment of the present invention may be regenerated by desorbing the moisture only by the compression heat of compressed air, thereby increasing the efficiency of producing dry air.

In addition, it is highly preferred to select an adsorbent having a Langmuir-type adsorption isotherm when producing a small amount of high-quality dry air due to its low moisture content and low relative humidity.

The compressed air introduced through the compressed air path 10 flows into the first adsorption tower 610 on one side of the adsorption towers 600 and comes into contact with the adsorbent, so that the moisture is adsorbed to be changed into dry air.

The dry air to which the moisture has been adsorbed is discharged along the dry air outflow path 40 to be transmitted to the after filter 700.

A part of the dry air generated in the adsorption tower 600 is recovered to the heat exchanger 200 and exchanged with the compressed air having the compression heat, so that the temperature may be heated to 70 to 80° C.

A part of the dry air generated in the adsorption tower 600 is bypassed by the opening of the first regeneration selection valve 31, and is introduced into the heat exchanger 200 along the dry air introduction path 20 to be heat-exchanged and heated with the compressed air having the compression heat.

The heated dry air is transported along the heated dry air introduction path 30, and flows into the second adsorption tower 620 on the other side of the adsorption towers by opening the second regeneration selection valve 32 to heat the adsorbent and desorb the adsorbent and is discharged through the purge discharge valve 15.

Through the heat exchanger 200, the compression heat generated when producing the compressed air production may be transferred to the dry air, and the heated dry air is used for regeneration of the adsorbent, thereby greatly increasing the production efficiency of the dry air.

The after filter 700 may extend from one side of the adsorption tower to remove contaminants from the dry air from which moisture has been removed.

The quality of the dry air is not determined only by the moisture content, and when the content of contaminants in the dry air is limited, the after filter 700 may be used to reduce the content of contaminants, thereby producing high-quality dry air.

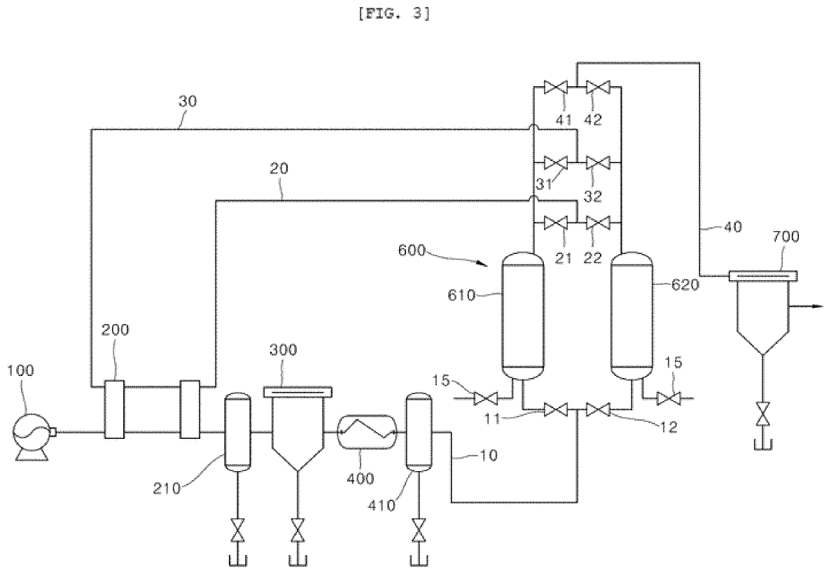

FIG. 3 is a process diagram illustrating a configuration of an energy-saving air dryer according to another embodiment of the present invention.

Referring to FIG. 3, an energy-saving air dryer according to the present invention includes a compressor 100, a heat exchanger 200, a pre-filter 300, a cooling dryer 400, an adsorption tower 600, and an after filter 500.

The compressor 100 compresses the air in the atmosphere to form compressed air.

While the compressor 100 compresses the air in the atmosphere, compression heat may be issued, and the compression heat may be recovered by heat exchange.

By compression of the compressor 100, the compressed air is heated to 80 to 100° C. due to compression heat. The compressed air compressed by the compressor 100 is introduced into the heat exchanger 200.

The heat exchanger 200 is disposed on one side of the compressor 100 and recovers the compression heat of the compressed air.

The heat exchanger 200 recovers the compression heat of 80 to 100° C. generated in the process of producing the compressed air by compressing the air in the atmosphere by the compressor 100 and transfers the compression heat to the dry air.

If the compression heat is not recovered, the compression heat is lost as waste heat, but when preliminary heat exchange with dry air introduced to one side is performed by providing the heat exchanger 200, the compression heat may be usefully used to heat the dry air.

At this time, the compressed air is cooled to room temperature of 30 to 40° C. due to the heat loss according to the heat exchange, and a part of the moisture in the compressed air is condensed by cooling to generate condensed water.

A separator 210 is provided on one side of the heat exchanger 200.

The separator 210 is disposed on one side of the heat exchanger 200 and may collect and discharge the condensed water generated by cooling of the compressed air.

The pre-filter 300 is disposed on one side of the heat exchanger 200 and removes contaminants from the compressed air.

The contaminants removed by the pre-filter 300 may have an average particle size larger than that of water vapor.

When the air in the atmosphere is compressed, the moisture content is increased, and contaminants such as dust and oil in the air in the atmosphere are also increased. Therefore, the contaminants are removed by using the pre-filter 300 to produce high-quality dry air.

The first regeneration selection valve 31 and the second regeneration selection valve 32 are provided at the ends of the heated dry air introduction path 30, and the heated dry air may be introduced selectively to an adsorption tower on one side of a pair of adsorption towers 600.

The MOF can be regenerated at a low temperature, so that the adsorbent filled in the adsorption tower is able to be regenerated only with the compression heat recovered through the heat exchanger without heating dry air.

The cooling dryer 400 is disposed around the pre-filter 300 of the heat exchanger 200, and a refrigerant flows into one side thereof to cool the compressed air and condenses moisture in the compressed air to discharge condensed water.

A separator 410 is provided on one side of the cooling dryer 400.

The separator 410 is disposed on one side of the heat exchanger 200 and may collect and discharge the condensed water generated by cooling of the compressed air.

The cooling dryer 400 may have a coolant introduced to one side to cool the compressed air to 4 to 6° C., and collect and discharge the moisture in the compressed air as condensed water.

The condensed water is collected and discharged by the separator 410.

When heat exchange between compressed air and dry air is performed by the heat exchanger 200, apart of the total moisture contained in the compressed air is removed by heat transfer without energy consumption, and when the cooling dryer 400 is provided, it is very effective in that some of the total moisture included in the compressed air may be further removed.

When the moisture is removed by preliminary heat exchange in the heat exchanger 200, and the main heat exchange is performed again using the cooling dryer, the moisture in the compressed air may be removed to 93 to 97 wt % of the total moisture adsorption amount.

Accordingly, a large amount of moisture in the compressed air is removed through the heat exchanger 200 and the cooling dryer 400 to greatly reduce the load of moisture which needs to be adsorbed by the adsorption tower 600, thereby increasing the adsorbent regeneration efficiency.

The compressed air from which moisture has been removed by the cooling dryer 400 flows into the adsorption tower 600 through the compressed air path 10.

At the end of the compressed air 10, the first adsorption inflow selection valve 11 and the second adsorption inflow selection valve 12 are installed.

Compressed air from which the first adsorption inflow selection valve 11 and the second adsorption inflow selection valve 12 are provided and condensed to remove some moisture may selectively flow into one side of the pair of adsorption towers 600.

The adsorption towers 600 are provided in a pair to consist of a first adsorption tower 610 and a second adsorption tower 620, and are connected to the cooling dryer 400, filled with the adsorbent, introduced with the compressed air along the opening and closing of the first adsorption inflow selection valve 11 or the second adsorption inflow selection valve 12, and adsorbed with the moisture to form dry air or receives the dry air having the compressing heat recovered from the heat exchanger 200 to desorb the moisture of the adsorbent.

The adsorption tower 600 is connected to the compressed air path 10 on one side, and connected with the dry air outflow path 40 on the other side, and includes a purge discharge valve 15.

The dry air outflow path 40 is provided with a first dry air outflow selection valve 41 and a second dry air outflow selection valve 42 at one end to transmit the produced dry air discharged from the adsorption tower on one side of the pair of adsorption tower 600 to the after filter 700 along the dry air outflow path 40.

The adsorption tower 600 is filled with an energy-saving adsorbent which has a moisture adsorption amount of 10 wt % or more to the weight of the adsorbent in a region of 10% relative humidity (P/P₀≤0.1) or less in the adsorption isotherm, and in which the adsorbed moisture of the adsorbent in the adsorption step is regenerable to dry air of 100° C. or less.

Specifically, the adsorbent may be a metal trimesate-based metal-organic framework, a metal terephthalate-based metal-organic structure, or a silicoaluminophosphate-based zeolite.

The MOF is a porous coordination polymer compound and has a crystalline skeleton, and a cluster of metal ions and an organic ligand are coordinated to form a skeleton.

The MOF has a specific surface area that is 3 to 5 times wider than that of silica gel or zeolite, and accordingly, has the adsorption amount of moisture of 2 to 4 times more, so that the MOF can be used as a moisture adsorbent. When using the MOF as an adsorbent in the adsorption tower of the air dryer, the specific surface area increases to exhibit a high moisture adsorption amount, and very effective desorption is enabled even at low temperatures.

Therefore, the moisture adsorbed by the adsorbent can be desorbed even by recovering only the compression heat generated when generating the compressed air.

On the other hand, aluminosilicate zeolite has a regeneration temperature much higher than MOF, so that additional energy is consumed in the dry air production process. High-quality dry air may be produced by adsorbing moisture even in compressed air with low relative humidity due to excellent moisture adsorption power from low relative humidity to high relative humidity, but it is not suitable for mass production of compressed air with low relative humidity.

When a large amount of moisture is contained, relative humidity is high, and dry air is produced in a large amount, MOF is selected as an adsorbent, and when the moisture content is low, the relative humidity is low, and the high-quality dry air is produced in small amount, it is preferred to select an adsorbent having a Langmuir-type adsorption isotherms.

In an embodiment of the present invention, the adsorbent may be MIL-100Fe or SAPO-34.

When the compressed air that has passed through the one-side adsorption tower comes into contact with the adsorbent, the moisture is adsorbed to be changed into dry air.

The adsorption tower 600 may discharge dry air by adsorbing moisture in the introduced compressed air in an amount of 1 to 30 wt % to the total moisture adsorption amount.

The dry air to which the moisture has been adsorbed through the adsorption tower 600 is transmitted to the after filter 700 along the dry air outflow path 40.

On the other hand, some of the dry air generated in the adsorption tower 600 is bypassed and introduced into the heat exchanger 200 along the dry air inflow path 20 and heated by exchanging heat with compressed air having compression heat.

The first adsorption outflow selection valve 21 and the second adsorption outflow selection valve 22 are provided at one end of the dry air introduction path 20 to determine whether to introduce dry air into the dry air introduction path 20.

Some of the dry air generated in the adsorption tower 600 is recovered to the heat exchanger 200 and heat-exchanged with the compressed air having the compression heat, so that the temperature may be heated to 70 to 80° C.

The heat exchanger 200 is connected with the pair of adsorption towers 600 through the heated dry air introduction path 30.

The dry air heated in the heat exchanger 200 flows into the other adsorption tower 620 of the pair of adsorption towers 600 along the heated dry air inflow path 30 to desorb the adsorbent and discharge the desorbed adsorbent through the purge discharge valve 15 by heating the adsorbent.

Through the heat exchanger 200, the compression heat generated when producing the compressed air production may be transferred to the dry air, and the heated dry air is used for regeneration of the adsorbent, thereby greatly increasing the production efficiency of the dry air.

Since the adsorbent can be regenerated at 70° C. to 80° C., the adsorbent is regenerated through the heated dry air, and there is no need to add energy consumed for regeneration, thereby greatly increasing the overall efficiency of the air dryer.

The after filter 700 may extend from one side of the adsorption tower 600 to remove contaminants from the dry air from which moisture has been removed.

The quality of the dry air is not determined only by the moisture content, and when the content of contaminants is determined, the after filter 700 may be used to reduce the content of contaminants, thereby producing high-quality dry air.

The dry air may be used in a process of requiring high-quality dry air because the moisture contained through the adsorption tower 600 is below a dew point of −40° C. under pressure, and contaminants are removed.

Meanwhile, in order to select the adsorbent according to the embodiment of the present invention, the adsorption performance over time was checked to confirm a production cycle.

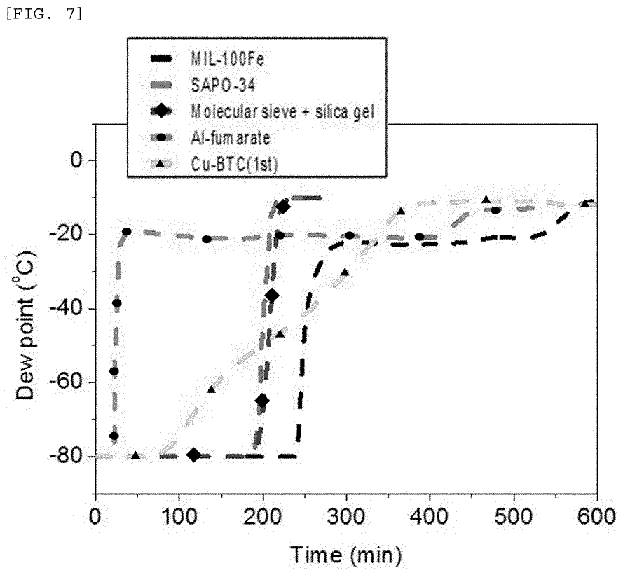

FIG. 7 is a moisture breakthrough curve according to a type of adsorbent according to an embodiment of the present invention.

First, referring to FIG. 7, in the case of a commercial adsorbent (molecular sieve+silica gel), a breakthrough curve of moisture appears after 180 minutes in a dry air production stage, and SAPO-34 also shows a breakthrough curve similar to that of the commercial adsorbent.

On the other hand, in the case of MIL-100Fe showing low-temperature desorption performance according to an embodiment of the present invention, it was confirmed that the breakthrough curve of moisture appeared after 220 minutes.

In addition, in the case of Al-fumarate with excellent low-temperature desorption performance, it was confirmed that the moisture breakthrough curve appeared after 20 minutes.

In the case of Cu-BTC, it was confirmed that a breakthrough curve of moisture appeared after 80 minutes.

Therefore, when comparing only the moisture adsorption performance, it was confirmed that the moisture adsorption performance was the highest in MIL-100Fe, and then in order of SAPO-34, commercial adsorbent (molecular sieve+silica gel), Cu-BTC, and Al-fumarate.

Among these adsorbents, a dry air production cycle was performed for MIL-100Fe and the commercial adsorbent (molecular sieve+silica gel) adsorbent with excellent performance.

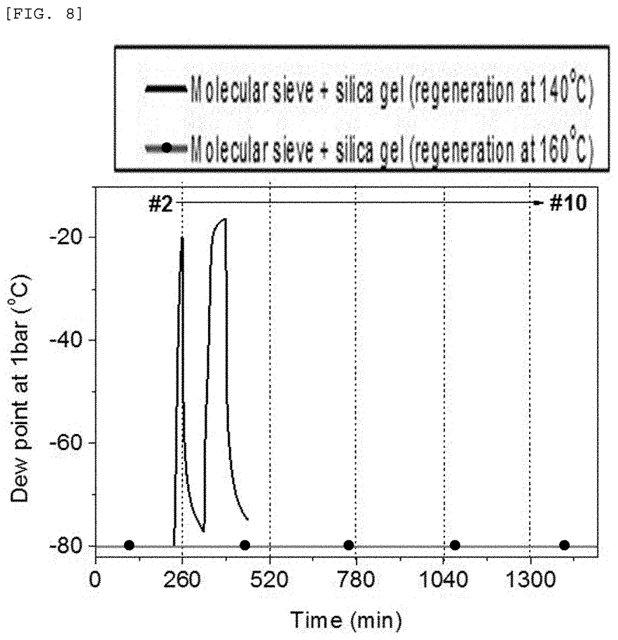

FIG. 8 is a curve showing a dry air production cycle for a conventional commercial adsorbent (molecular sieve+silica gel).

Referring to FIG. 8, the moisture adsorption and desorption cycle results were performed at adsorption temperature of 30° C., adsorption pressure of 7 bar, adsorption flow rate of 4 L/min, adsorption and desorption cycle time of 120 minutes (adsorption of 60 minutes, desorption of 60 minutes), desorption flow rate of 0.3 L/min, and desorption temperature of 140 to 160° C.

In the case of commercial adsorbents, it can be seen that regeneration is not performed from the third cycle when moisture is desorbed at 140° C.

On the other hand, in the case of desorption of moisture at 160° C., it was confirmed that moisture adsorption and desorption were repeated up to 10 cycles or more.

It was confirmed that commercial adsorbents had to be repeatedly regenerated at high temperatures in order to produce dry air.

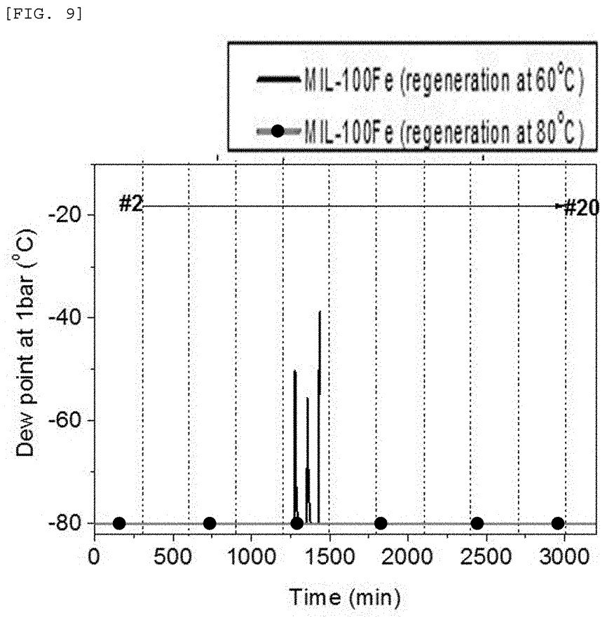

FIG. 9 is a curve showing a dry air production cycle for an MIL-100 adsorbent according to an embodiment of the present invention.

Referring to FIG. 9, the moisture adsorption and desorption cycle results were performed at adsorption temperature of 30° C., adsorption pressure of 7 bar, adsorption flow rate of 4 L/min, adsorption and desorption cycle time of 170 minutes (adsorption of 85 minutes, desorption of 85 minutes), desorption flow rate of 0.3 L/min, and desorption temperature of 60 to 80° C.

In the case of the MIL-100Fe adsorbent according to an embodiment of the present invention, it was confirmed that moisture adsorption and desorption were repeated until more than 20 cycles when moisture was desorbed at 80° C.

It was confirmed that the desorption temperature of 80° C. or more may be reduced compared to the commercial adsorbent.

Therefore, in an embodiment of the present invention, MIL-100Fe or SAPO-34 along a Langmuir-type adsorption isotherm was selected as the adsorbent in consideration of the moisture adsorption amount, production cycle, and desorption temperature.

Hereinafter, an operation order of the energy-saving air dryer will be described.

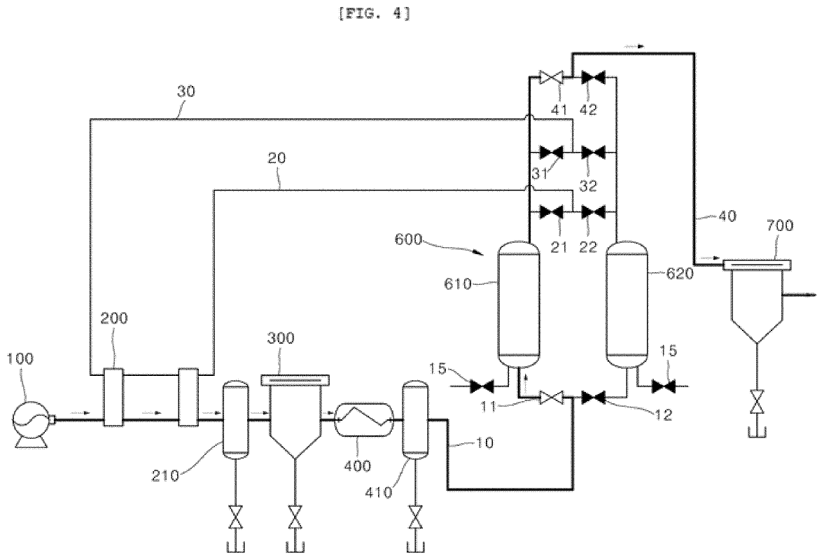

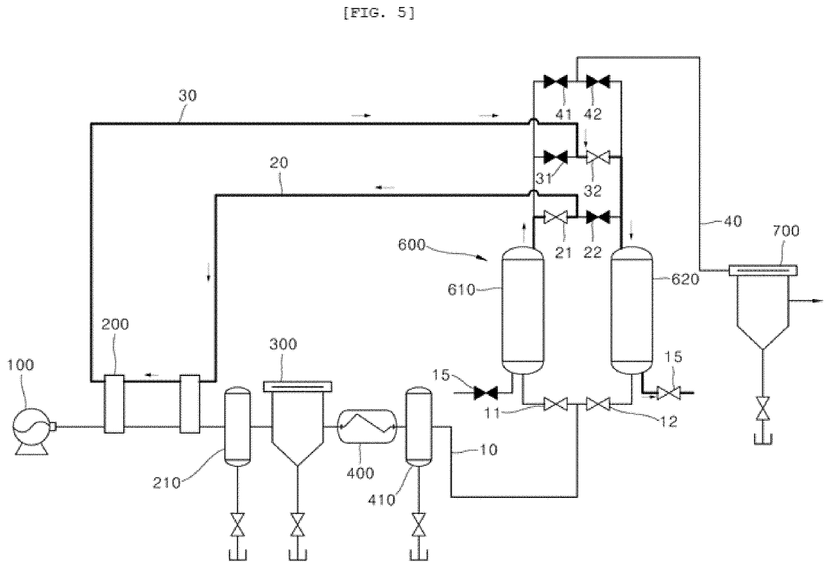

FIG. 4 is a process diagram illustrating a flow of compressed air when an adsorption process is performed in the energy-saving air dryer according to another embodiment of the present invention and FIG. 5 is a process diagram illustrating a flow of dry air when a desorption process is performed in the energy-saving air dryer according to another embodiment of the present invention.

Referring to FIG. 4, when an adsorption cycle will be described, the compressed air generated in the compressor 100 passes through the heat exchanger 200 to remove some moisture from the compressed air through preliminary heat exchange, and is introduced into the cooling dryer 400 again.

In the cooling dryer 400, compressed air is cooled by main heat exchange with a coolant, and some of moisture is cooled to form condensed water.

The compressed air from which the moisture has been partially removed flows into the adsorption tower 610 on one side along the compressed air 10 and comes into contact with the adsorbent to adsorb moisture.

The compressed air flows into the adsorption tower on one side by opening the first adsorption inflow selection valve 11 provided at the end of the compressed air 10, and at this time, selects the second adsorption inflow selection valve 12 connected to the adsorption tower 620 on the other side is closed.

The adsorption tower 610 produces dry air by adsorbing moisture from compressed air.

The purge discharge valve 15 provided at one side of the pair of adsorption towers 600 is closed, and the first dry air discharge selection valve 41 provided at the end of the dry air outflow path 40 is opened, so that the dry air is transmitted to the after filter 700 by moving along the dry air outflow path 40.

The dry air is filtered by the after filter 700 and transmitted to a process of requiring high-quality dry air.

Meanwhile, the dry air is partially bypassed and transmitted to the heat exchanger 200.

The dry air generated in the adsorption tower 610 is introduced into the heat exchanger 200 along the dry air introduction path 20 by opening the first adsorption outflow selection valve 21.

The heat exchanger 200 receives the compression heat of compressed air and is introduced into a desorption cycle to be described below.

The after filter 700 filters dry air to remove contaminants and discharges dry air.

Referring to FIG. 5, when the desorption cycle is described, the first adsorption outflow selection valve 21 is opened, and the dry air flows into the heat exchanger 200 along the dry air introduction path 20.

The dry air is compressed in the heat exchanger 200 to preliminarily heat exchange with compressed air generated compressed heat to be heated by receiving the compression heat.

The dry air may be heated to 80 to 100° C.

The first regeneration selection valve 31 disposed at the end of the heated dry air introduction path 30 is closed, and the second regeneration selection valve 32 is opened, so that the heated dry air flows into the adsorption tower 620 on the other side.

At this time, the heated dry air moves downward of the adsorption tower 620 to desorb the adsorbent containing moisture.

When compressed air is introduced to adsorb moisture, the adsorbent located at the bottom of the adsorption tower first adsorbs moisture, and the adsorbent at the upper part adsorbs little moisture.

When the heated dry air is introduced from the upper part of the adsorption tower 600 and moves downward, the heated dry air is located at the lower part without affecting the adsorbent which does not adsorb the moisture to be effectively desorbed by heating only the adsorbent containing a large amount of moisture.

The adsorption tower 620 on the other side may adsorb moisture to be adsorbed through an adsorption cycle, and may be an adsorption tower 620 that needs preparation to desorb a small amount of moisture remaining before the initial adsorption process.

After the heated dry air desorbs the moisture adsorbed by the adsorbent and regenerates the adsorbent, the purge discharge valve 15 provided at one side of the adsorption tower 620 is opened and discharged.

The adsorption tower 600 is provided in a pair, and the adsorbent adsorbs moisture to the one adsorption tower, and the other adsorption tower desorbs moisture by inflow of dry air to regenerate the adsorbent, and the adsorption and desorption of moisture are alternately repeatedly performed.

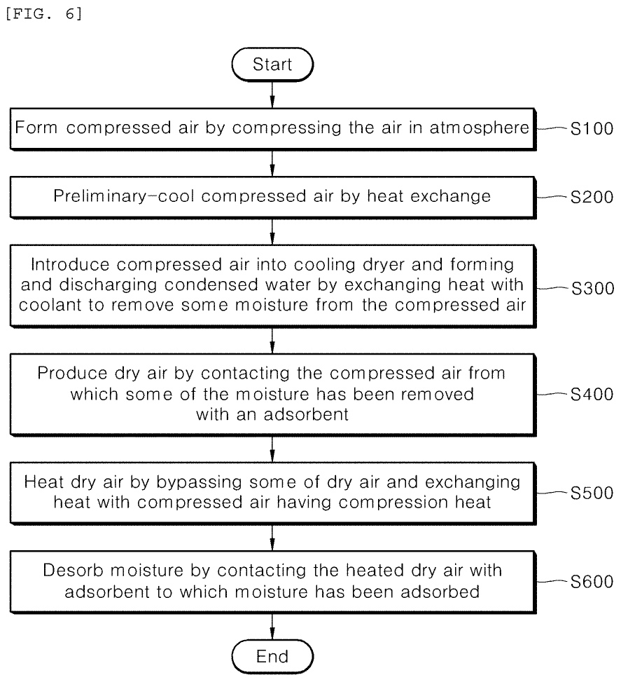

FIG. 6 is a process flowchart illustrating a procedure of a method for producing dry air through the energy-saving air dryer according to another embodiment of the present invention.

Referring to FIG. 6, the present invention provides the steps of: compressing the air in the atmosphere to form compressed air (step 1):

preliminary-cooling the compressed air by heat exchange (step 2);

introducing the compressed air into a cooling dryer and forming and discharging condensed water by exchanging heat with a coolant to remove some of the moisture from the compressed air (step 3);

producing dry air by contacting the compressed air from which some of the moisture has been removed with an adsorbent (step 4);

heating the dry air by bypassing some of the dry air and exchanging heat with compressed air having compression heat (step 5); and

desorbing moisture by contacting the heated dry air with the adsorbent to which moisture has been adsorbed (step 6).

First, compressed air is generated by compressing the air of the atmosphere (S100).

In the process of forming the compressed air, compression heat is generated.

The compression heat may be recovered through heat exchange to desorb the moisture adsorbed on the adsorbent. The compressed air is pre-cooled by heat exchange through the heat exchanger, and at this time, some of the moisture in the compressed air is condensed and discharged (S200).

In the cooling dryer, this heat exchange is performed, and a large amount of moisture in the compressed air may be condensed and discharged by cooling the compressed air by the coolant (S300).

Through heat exchange between S200 and S300, the moisture in the compressed air may be removed from 85 to 95 wt % of the total moisture adsorption amount.

After a large amount of moisture in the compressed air is removed through the heat exchange, the moisture in the compressed air comes into contact with the adsorbent, thereby greatly reducing the load of the moisture adsorption amount of the adsorbent.

Thereafter, dry air is produced by contacting the compressed air from which some moisture has been removed with the adsorbent (S400).

In S400, the adsorbent is filled with an energy-saving adsorbent which has a moisture adsorption amount of 10 wt % or more to the weight of the adsorbent in a region of 10% relative humidity (P/P₀≤0.1) or less in the adsorption isotherm, and in which the adsorbed moisture of the adsorbent in the adsorption step is regenerable to dry air of 100° C. or less.

Specifically, the adsorbent may be a metal trimesate-based metal-organic framework, a metal terephthalate-based metal-organic structure, or a silicoaluminophosphate-based zeolite.

Compared to conventional commercial adsorbents, the adsorbent is regenerated by desorption of moisture at a low temperature, thereby greatly increasing the producing cost and process efficiency of the dry air.

The compressed air from which some of the moisture has been removed comes into contact with the adsorbent, and the moisture is adsorbed to be changed into dry air.

In S400, the compressed air may be brought into contact with the adsorbent to adsorb 1 to 30 wt % of the total moisture.

The dry air in contact with the adsorbent to which moisture is adsorbed may be high-quality dry air having a dew point of −40° C. or less under pressure.

Some of the dry air to which moisture has been adsorbed by contacting the adsorbent is recovered and introduced into the heat exchange process of step 2, and heated by heat exchange with the compressed air having compressed heat.

The heated dry air regenerates the adsorbent by desorbing the moisture by contacting the adsorbent to which moisture has been adsorbed again.

S400 and S600 may be performed by crossing each other, and the steps of producing the dry air from S100 to S400 may be repeatedly performed to obtain high-quality dry air.

According to yet another embodiment of the present invention, the present invention provides an energy-saving air dryer.

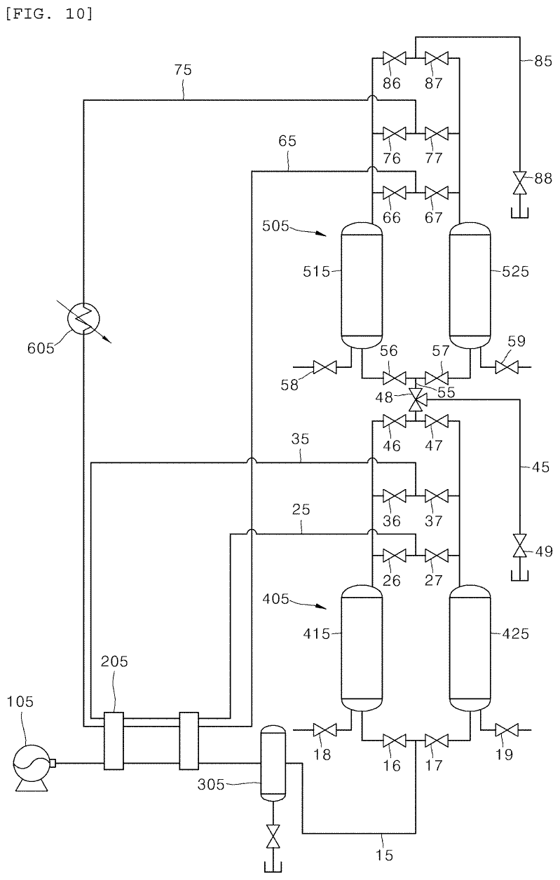

FIG. 10 is a process diagram illustrating a configuration of an energy-saving air dryer according to yet another embodiment of the present invention.

Referring to FIG. 10, an energy-saving air dryer according to an embodiment of the present invention includes a compressor 105, a heat exchanger 205, a pre-filter 305, a first adsorption tower 405, and a second adsorption tower 505.

An energy-saving air dryer according to yet another embodiment of the present invention is provided with a first adsorption tower 405 for producing first dry air having a dew point of 2 to 10° C. and a second adsorption tower 505 for producing and supplying second drying air having a dew point of −40° C. or less to determine the quality of the dry air and selectively supply the dry air.

The compressor 105 is connected to the compressed air path 15, and the compressed air path 15 is connected to the first adsorption tower 405.

The first adsorption tower 405 is connected to the second adsorption tower 505 through the first dry air introduction path 55, and the second adsorption tower 505 is connected to the second dry air outflow path 85.

Hereinafter, the compressed air path 15, the first dry air inflow path 25, the first heated dry air inflow path 35, the first dry air outflow path 45, the first dry air introduction path 55, the second dry air inflow path 65, the second heated dry air inflow path 75, and the second dry air outflow path 85 provide pipelines in which compressed air, dry air, dry air heated by heat exchange with compressed air, dry air from which moisture is constantly removed, and high-quality dry air flow, respectively. A first inflow selection left valve 16, a first inflow selection right valve 17, a first purge left valve 18, a first purge right valve 19, a first outflow selection left valve 26, a first outflow selection right valve 27, a first regeneration selection left valve 36, a first regeneration selection right valve 37, a first dry air outflow selection left valve 46, a first dry air outflow selection right valve 47, a first dry air outflow selection three-way valve 48, a first dry air discharge valve 49, a second inflow selection left valve 56, a second inflow selection right valve 57, a second purge left valve 58, a second purge right valve 59, a second outflow selection left valve 66, a second outflow selection right valve 67, a second regeneration selection left valve 76, a second regeneration selection right valve 77, a second dry air outflow selection left valve 86, a second dry air outflow selection right valve 87, and a second dry air discharge valve 88 are provided at ends of the pipelines and may be connected to a controller (not illustrated) to control opening and closing. The controller may determine opening and closing of each valve according to a producing order of the dry air.

The compressor 105 compresses the air in the atmosphere to form compressed air.

While the compressor 105 compresses the air in the atmosphere, compression heat is generated by friction of air, and the compression heat may be used as an energy source capable of regenerating dry air.

By compression of the compressor 105, the compressed air is heated to 80 to 100° C. due to compression heat.

The compressed air compressed by the compressor 105 is introduced into the heat exchanger 201.

The heat exchanger 205 is disposed on one side of the compressor 105 and recovers the compression heat of the compressed air.

If the compression heat is not recovered, the compression heat is lost as waste heat, but when preliminary heat exchange with dry air introduced to one side is performed by providing the heat exchanger 205, the compression heat may be usefully used to heat the dry air.

The pre-filter 305 is disposed on one side of the heat exchanger 205 and removes contaminants from the compressed air.

The contaminants removed by the pre-filter 305 may have an average particle size larger than that of water vapor.

When the air in the atmosphere is compressed, the moisture content is increased, and contaminants such as dust and oil in the air in the atmosphere are also increased. Therefore, the contaminants are removed by using the pre-filter 305 to produce high-quality compressed air.

At the end of the compressed air path 15, the first inflow selection left valve 16 and the first inflow selection right valve 17 is disposed to be determined to selectively flow into one side of a first adsorption tank 405.

The first inflow selection left valve 16 and the first inflow selection right valve 17 are selectively opened to each other, and when the first inflow selection left valve 16 is opened, the first inflow selection right valve 17 Is closed, and compressed air may flow into a first adsorption left tower 415 through the first inflow selection left valve 16.

The first adsorption tower 405 is disposed on one side of the pre-filter 305, the first adsorbent is filled, and compressed air is introduced according to the opening and closing of the valve to adsorb moisture in the compressed air to produce dry air.

The first adsorption tower 405 includes a first adsorption left tower 415 and a second adsorption right tower 425.

The first adsorption seat tower 415 and the second adsorption right tower 425 are filled with a first adsorbent to adsorb a certain amount of moisture contained in compressed air to produce and supply first dry air.

FIG. 2 is an adsorption isotherm according to a type of adsorbent filled in an adsorption tower in the energy-saving air dryer according to yet another embodiment of the present invention.

Referring to FIG. 2, the first adsorbent has a moisture adsorption amount of 30 wt % or more to the weight of the adsorbent in a region with a relative humidity of 5 to 40% (0.05≤P/P₀≤0.5) in the adsorption isotherm, and may be regenerable to dry air at less than 100° C.

Specifically, the adsorbent may be a metal trimesate-based metal-organic framework, a metal terephthalate-based metal-organic structure or silicoaluminophosphate-based zeolite.

The MOF is a porous coordination polymer compound and has a crystalline skeleton, and a cluster of metal ions and an organic ligand are coordinated to form a skeleton.

The MOF has a specific surface area that is 3 to 5 times wider than that of silica gel or zeolite, and accordingly, has the adsorption amount of moisture of 2 to 4 times more, so that the MOF can be used as a moisture adsorbent. When using the MOF as an adsorbent in the adsorption tower of the air dryer, the specific surface area increases to exhibit a high moisture adsorption amount, and very effective desorption is enabled even at low temperatures.

The MOF is preferable because moisture adsorbed by the adsorbent can be desorbed even by recovering only the compression heat generated when generating the compressed air.

Specifically, the MOF may be metal trimesate-based MIL-100X (X=any one of metals consisting of Fe, Cr, Al and V) and its derivatives, and metal terephthalate-based MIL-101X (X=any one of metals consisting of Cr, Fe and Al) and derivatives thereof, which exhibit Sigmoid type adsorption behavior in adsorption isotherms, and have moisture adsorption amount of 30 wt % or more relative to the weight of adsorbent.

In yet another embodiment of the present invention, the first adsorbent is preferably MIL-100Fe or MIL-101Cr.

When the MOF is selected as MIL-100Fe or MIL-101Cr, the absorbent can regenerate by using the compression heat of 80 to 100° C. generated in the compression process of the air of the atmosphere in the compressor 105, thereby greatly increasing the drying air production efficiency, and is anon-heating type, it has an advantage of maintaining the strength of the adsorbent for a long time.

The compressed air is introduced into the adsorption tower on one side of the first adsorption tower 405, and moisture is adsorbed by the first adsorbent to change to dry air having a dew point of 2° C. to 10° C.

The first dry air discharge valve 49 is provided at one side of the first adsorption tower 405, and dry air having a dew point of 2° C. to 10° C. may be supplied through the first dry air discharge valve 49.

The dry air discharge valve 49 may be provided to discharge and supply dry air from which a certain amount of moisture contained in compressed air is removed.

Hereinafter, the dry air produced through the first adsorption tower 405 refers to first dry air, and the dry air produced through the second adsorption tower 505 refers to second dry air.

The first adsorption tower 405 may be compressed to very effectively remove moisture from the compressed air, which has a high relative humidity of 90 to 100%, and the first adsorbent filled in the first adsorption tower 400 is very advantageous to produce dry air in large quantities as the adsorption amount increases rapidly as the vapor pressure increases in an adsorption isotherm.

A first flow selection left valve 26 and a first flow selection right valve 27 are disposed above the first adsorption tower 405.

The first outflow selection left valve 26 or the first outflow selection right valve 27 is selectively opened so that the first drying air is introduced into the heat exchanger 205 along the first drying air inflow path 25.

When some of the dry air produced in the first adsorption tower 405 is branched and introduced into the heat exchanger 205, some of the dry air is heated by heat exchange with the compression heat.

The first drying air heated by the heat exchange is recovered to one side of the first adsorption tower 405 along the first heated dry air inflow path 35.

At the end of the first heated dry air inflow path 35, the first regeneration selection left valve 36 and the first regeneration selection right valve 37 are disposed.

When the first regeneration selection left valve 36 or the first regeneration selection right valve 37 is selectively opened, the adsorbent in which moisture is adsorbed is introduced into any one adsorption tower of the first adsorption towers 405 and heated to desorb the moisture, thereby regenerating the adsorbent.

When the compression heat is maintained at less than 100° C. and the compression heat of less than 100° C. is generated, dry air introduced into the heat exchanger 205 is heated to flow into one side of the first adsorption tower 405 and the moisture adsorbed on the first adsorbent is desorbed to regenerate the first adsorbent.

At upper part of the first adsorption tower 405, the first dry air outflow selection left valve 46 and the first dry air outflow selection right valve 47 are disposed.

The first dry air outflow selection left valve 46 or the first dry air outflow selection right valve 47 may be selectively opened to allow the produced first dry air to flow out.

Meanwhile, the first adsorption tower 405 and the second adsorption tower 505 are arranged in series through the first dry air introduction path 55.

The first dry air introduction path 55 is connected to the first dry air outflow selection three-way valve 48 to selectively introduce the first dry air produced in the first adsorption tower 405.

The second adsorption tower 505 is disposed on one side of the first adsorption tower 405, and filled with the second adsorbent to allow dry air discharged from the first adsorption tower 405 to flow in and adsorb the remaining moisture in the first dry air.

The second adsorption tower 505 is arranged in series with the first adsorption tower 405, and a shearing process of firstly removing moisture from compressed air is performed in the first adsorption tower 405. Selectively, the first dry air produced in the first adsorption tower 405 is introduced to re-adsorb the remaining moisture in the dry air and produce high-quality dry air with a significantly reduced moisture content compared to the first dry air, so that the high-quality dry air can be effectively supplied to a semiconductor process and pneumatic equipment.

The second adsorption tower 505 includes a second adsorption left tower 515 and a second adsorption right tower 525.

At the end of the first dry air introduction path 55, the second inflow selection left valve 56 and the second inflow selection right valve 57 are disposed so that the first dry air may be selectively introduced to the second adsorption tower 505.

The second inflow selection left valve 56 and the second inflow selection right valve 57 are selectively opened to each other, and when the second inflow selection left valve 56 is opened, the second inflow selection right valve 57 Is closed, and compressed air may flow into a second adsorption left tower 515 through the second inflow selection left valve 56.

The second adsorption left tower 515 and the second adsorption right tower 525 are filled with the second adsorbent.

The second adsorbent may have a moisture adsorption amount of 10 wt % or more to the weight of the adsorbent in a region of 10% relative humidity (P/P₀≤0.1) or less in the adsorption isotherm.

The second adsorbent has strong hydrophilicity and may exhibit a Langmuir type adsorption behavior in the adsorption isotherm.

The second adsorbent has a large moisture adsorption amount even in the relative humidity range with a small moisture content, so it is easy to produce high-quality dry air, but it is difficult to produce dry air in large quantities by requiring a relatively high desorption temperature of 100 to 200° C. in order to desorb the moisture adsorbed on the adsorbent. Accordingly, the second adsorption tower 505 filled with the second adsorbent according to another embodiment of the present invention selectively operates when high-quality dry air is required.

Specifically, the second adsorbent may be silicoaluminophosphate zeolite.

At the upper part of the second adsorption tower 505, the second outflow selection left valve 66 and the second outflow selection right valve 67 are disposed to selectively discharge the produced dry air, and the dry air may be transmitted to the heat exchanger 205 along the second dry air inflow path 65. The second dry air produced in the second adsorption tower 505 is introduced into the heat exchanger 205 according to the opening and closing of the second outflow selection left valve 66 and the second outflow selection right valve 67, and heated by exchanging heat with compression heat generated by compressing the air in the atmosphere in the compressor 105.

The second dry air may pass through the heat exchanger 205 and be heated to less than 100° C. and then pass through a heater 605 disposed at one side of the heat exchanger 205 to be heated to 100 to 200° C.

The heater 605 is connected to a second heating air inflow path 75, and at the end of the second heating air inflow path 75, a second regeneration selection left valve 76, and a second regeneration selection right valve 77 is disposed.

The second regeneration left valve 76 or the second regeneration right valve 77 is selectively opened, so that the heated second dry air flows into one of the second adsorption tower 505 to desorb moisture by heating the second adsorbent adsorbed with moisture, thereby regenerating the second adsorbent.

The second adsorption tower 505 includes a second dry air outflow selection left valve 86, a second dry air outflow selection right valve 87, and a second dry air discharge valve 88.

The second dry air outflow selection left valve 86 or the second dry air outflow selection right valve 87 is selectively opened to discharge high-quality second dry air.

The second dry air discharge valve 88 is opened when the second dry air reaches, to supply high-quality dry air.

Meanwhile, in order to select the adsorbent according to yet another embodiment of the present invention, the adsorption performance over time was checked to confirm a production cycle.

FIG. 7 is a moisture breakthrough curve according to a type of adsorbent filled in an adsorption tower in the energy-saving air dryer according to an embodiment of the present invention.

First, referring to FIG. 7, in the case of a commercial adsorbent (molecular sieve+silica gel), a breakthrough curve of moisture appears after 180 minutes in a dry air production stage, and SAPO-34 also shows a breakthrough curve similar to that of the commercial adsorbent.

On the other hand, in the case of MIL-100Fe showing low-temperature desorption performance according to an embodiment of the present invention, it was confirmed that the breakthrough curve of moisture appeared after 220 minutes.

In addition, in the case of Al-fumarate with excellent low-temperature desorption performance, it was confirmed that the moisture breakthrough curve appeared after 20 minutes.

In the case of Cu-BTC, it was confirmed that a breakthrough curve of moisture appeared after 80 minutes.

Therefore, when comparing only the moisture adsorption performance, it was confirmed that the moisture adsorption performance was the highest in MIL-100Fe, and then in order of

SAPO-34, commercial adsorbent (molecular sieve+silica gel), Cu-BTC, and Al-fumarate.

Among these adsorbents, a dry air production cycle was performed for MIL-100Fe and the commercial adsorbent (molecular sieve+silica gel) adsorbent with excellent performance.

FIG. 8 is a curve showing a dry air production cycle for a conventional commercial adsorbent (molecular sieve+silica gel).

Referring to FIG. 8, the moisture adsorption and desorption cycle results were performed at adsorption temperature of 30° C., adsorption pressure of 7 bar, adsorption flow rate of 4 L/min, adsorption and desorption cycle time of 120 minutes (adsorption of 60 minutes, desorption of 60 minutes), desorption flow rate of 0.3 L/min, and desorption temperature of 140 to 160° C.

In the case of commercial adsorbents, it can be seen that regeneration is not performed from the third cycle when moisture is desorbed at 140° C.

On the other hand, in the case of desorption of moisture at 160° C., it was confirmed that moisture adsorption and desorption were repeated up to 10 cycles or more.

It was confirmed that commercial adsorbents had to be repeatedly regenerated at high temperatures in order to produce dry air.

FIG. 9 is a curve showing a dry air production cycle for an MIL-100 adsorbent in an energy-saving air dryer according to yet another embodiment of the present invention.

Referring to FIG. 9, the moisture adsorption and desorption cycle results were performed at adsorption temperature of 30° C., adsorption pressure of 7 bar, adsorption flow rate of 4 L/min, adsorption and desorption cycle time of 170 minutes (adsorption of 85 minutes, desorption of 85 minutes), desorption flow rate of 0.3 L/min, and desorption temperature of 60 to 80° C.

In the case of the MIL-100Fe adsorbent according to yet another embodiment of the present invention, it was confirmed that moisture adsorption and desorption were repeated until more than 20 cycles when moisture was desorbed at 80° C.

It was confirmed that the desorption temperature of 80° C. or more may be reduced compared to the commercial adsorbent. Accordingly, in yet another embodiment of the present invention, it was confirmed that the first adsorbent filled in the first adsorption tower is preferably to select MIL-100Fe in consideration of the moisture adsorption amount, production cycle, and desorption temperature.

Hereinafter, an operation order of an energy saving air dryer according to yet another embodiment of the present invention will be described.

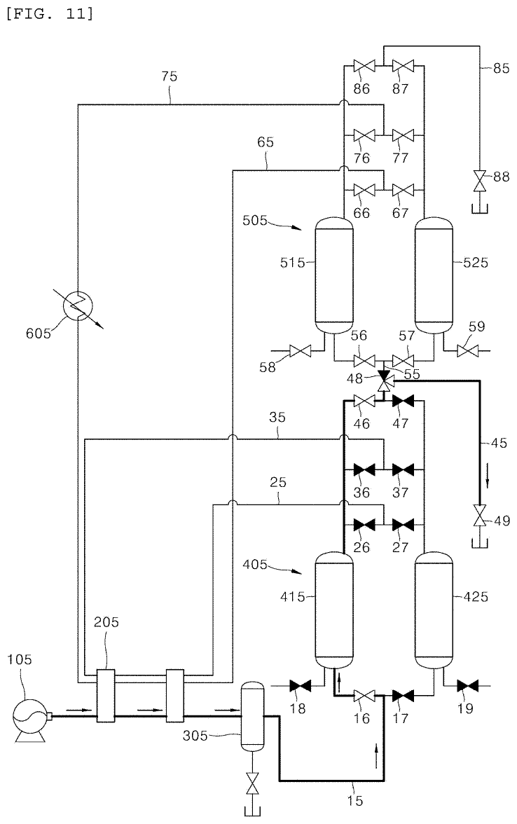

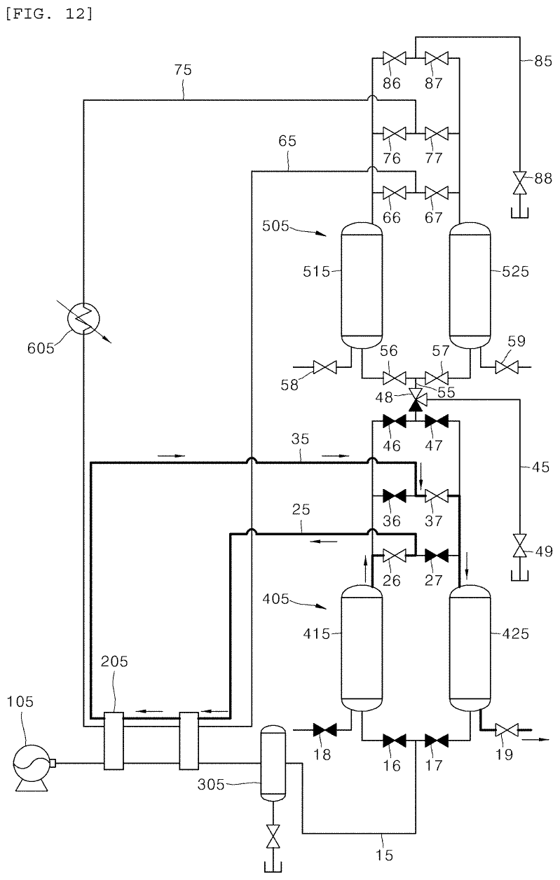

FIG. 11 is a process diagram illustrating a flow of compressed air when an adsorption process in a first adsorption tower is performed in the energy-saving air dryer according to yet another embodiment of the present invention and FIG. 12 is a process diagram illustrating a flow of dry air when a desorption process in the first adsorption tower is performed in the energy-saving air dryer according to yet another embodiment of the present invention.

First, when the adsorption process of the first adsorption tower 405 is described with reference to FIG. 11, the compressed air generated by the compressor 105 is compressed and moves along the compressed air path 15 with compressed heat.

The compressed air is introduced into the heat exchanger 205, transfers compression heat to dry air flowing to one side, is cooled, and then reaches the first inflow selector left valve 16.

The heat exchange of the heat exchanger 205 is performed by alternately repeating a process of recovering compression heat in an adsorption process and a process of introducing dry air introduced in the desorption process.

When the first inflow selection left valve 16 is opened, the first inflow selection right valve 17 is closed so that the compressed air flows along the first inflow selection left valve 16 to the first adsorption left tower 415.

The first adsorption left tower 415 adsorbs moisture in compressed air to produce first dry air.

The first dry air outflow selection valve 46 is disposed above the first adsorption tower 405, and the first dry air outflow selection left valve 46 is opened to discharge the first dry air.

The first dry air reaches the first dry air outflow selection three-way valve 48 and is introduced into one side of the second adsorption tower 505, or discharged to the first dry air discharge valve 49.

In the case of mass production of dry air of which moisture content is constantly reduced in compressed air and not requiring high-quality dry air, the valve in the direction of the second adsorption tower 505 in the first dry air outflow selection three-way valve 48 is closed, the produced first dry air reaches the first dry air discharge valve 49, and the first dry air discharge valve 49 is opened to supply first dry air.

The first dry air has a dew point of 2 to 10° C. under the outlet pressure of the first dry air discharge valve 49.

The first dry air may greatly reduce the energy used for regeneration of the first adsorbent required for adsorption of moisture, and a large amount of moisture adsorption within the pressure range of the compressed air mass-produces dry air.

On the other hand, in the case of semiconductor processes or expensive pneumatic equipment, higher quality dry air is required, so there is a need to remove moisture remaining in the first dry air. In this case, the first dry air is transmitted to the second adsorption tower to be introduced in a post-process to reduce the moisture content.

Referring to FIG. 12, some of the first dry air is introduced to the first dry air inflow path 25 by opening the first outflow selection left valve 26 disposed at the upper part of the first adsorption left tower 415.

The dry air introduced into the first dry air inflow path 25 is introduced into the heat exchanger 205 and heated to less than 100° C. by receiving compression heat in the heat exchanger.

The heated dry air reaches the first regeneration selection right valve 37 along the first heated dry air inflow path 35, and is introduced into the first adsorption right tower 425 to desorb moisture by heating a desorbent in which the moisture is adsorbed through the adsorption process.

The first purge valve 19 is disposed on one side of the first adsorption right tower 425 so that the dry air from which moisture is desorbed is not circulated to the first adsorption tower 405, but is discharged to the outside.

The adsorption process and the desorption process are alternately performed, and when the adsorption process is performed in the first adsorption left tower 415, the desorption process is performed in the first adsorption right tower 425, and the adsorption and desorption are completed. In the next cycle, the adsorption process is performed in the first adsorption right tower 425, and the desorption process is performed at the first adsorption left tower 415.

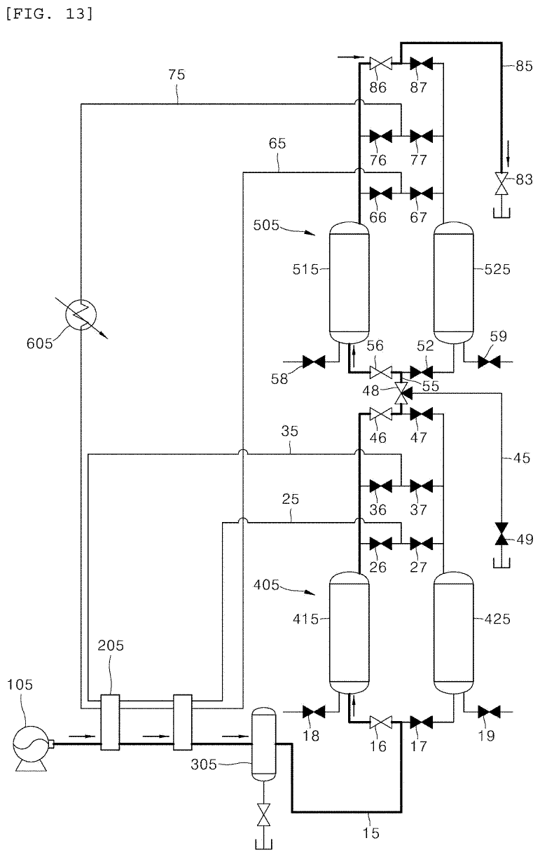

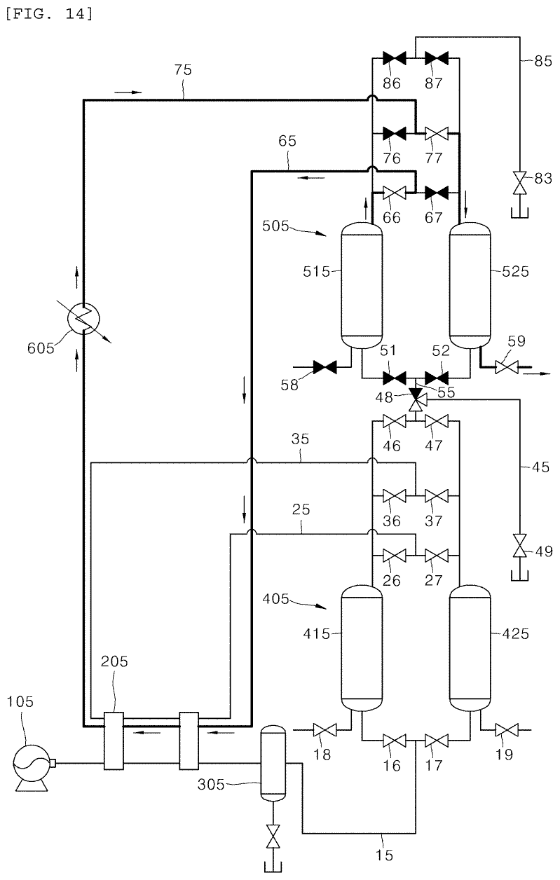

FIG. 13 is a process diagram illustrating a flow of compressed air when an adsorption process in a second adsorption tower is performed in the energy-saving air dryer according to yet another embodiment of the present invention and FIG. 14 is a process diagram illustrating a flow of dry air when a desorption process in the second adsorption tower is performed in the energy-saving air dryer according to yet another embodiment of the present invention.

Referring to FIG. 13, the first drying air from which some of the moisture in the compressed air has been removed from the first adsorption left tower 415 reaches the second inflow selection left valve 56 or the second inflow selection right valve 57 along the first dry air introduction path 55.

When the second inflow selection left valve 56 is opened, the second inflow selection right valve 57 is closed so that the first dry air flows along the second inflow selection left valve 56 to the second adsorption left tower 515.

The second adsorbent filled in the second adsorption left tower 515 very effectively adsorbs moisture remaining in the first dry air with a relatively low relative humidity of 10% (P/P₀≤0.1) or less, thereby producing high-quality dry air.

The second dry air from which moisture has been removed by passing through the second adsorption left tower 515 is introduced into the second dry air outflow path 85 along the second dry air outflow selection left valve 86 disposed on the second adsorption left tower 515.

The second dry air reaches the second dry air discharge valve 88 through the second dry air outflow path 85, and high-quality dry air may be supplied by opening and closing the second dry air discharge valve 88.

The second dry air may produce high-quality dry air having a dew point of −40° C. or less under the pressure of the second dry air discharge valve 88.

Referring to FIG. 14, when the desorption process of the second adsorption tower 505 will be described, some of the second dry air from which moisture has been removed through the second adsorption left tower 515 is branched to be introduced to the second dry air inflow path 65.

The second dry air introduced into the second dry air inflow path 65 reaches the heat exchanger 205 and heated to less than 100° C. by receiving the compression heat in the compressed air.

Since the second adsorbent has a desorption temperature of 100 to 200° C., the second dry air passes through the heater 605 and is heated to 150° C.

The second dry air further heated by passing through the heater 605 reaches the second regeneration selection right valve 77 through the second heated dry air inflow path 75.

The second dry air flows into the second adsorption right tower 525, heats the second adsorbent to desorb the adsorbed moisture, and then is discharged to the outside through the second purge valve 59 provided on one side of the second adsorption right tower 525.

Like the adsorption and desorption process of the first adsorption tower 405, the adsorption process and desorption process in the second adsorption tower 505 are alternately performed. When the adsorption process is performed in the second adsorption seat 515, the desorption process is performed in the second adsorption right tower 525. After the adsorption and desorption is completed, in the next adsorption and desorption cycle, the adsorption process is performed in the second adsorption right tower 525, and the desorption process is performed at the second adsorption left tower 515

According to yet another embodiment of the present invention, the present invention provides a method for producing dry air using an energy-saving air dryer.

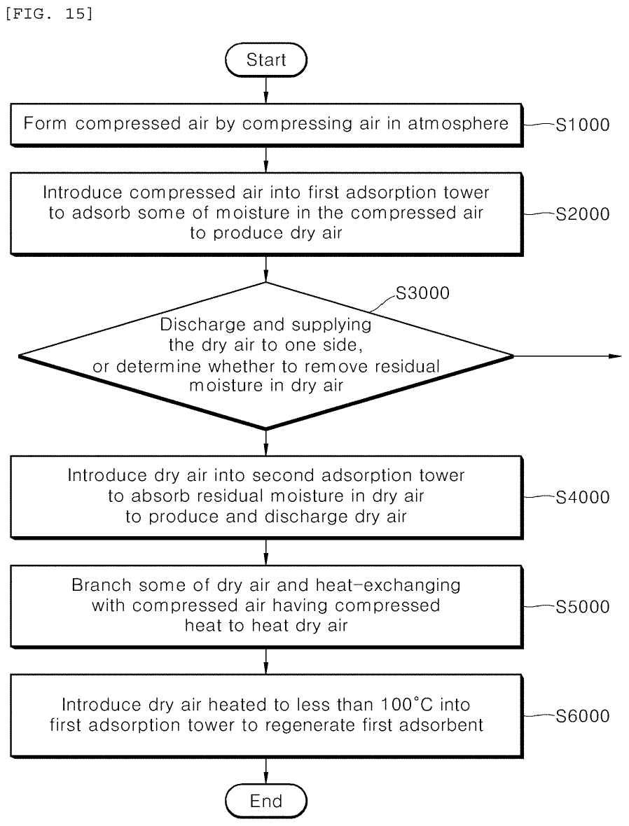

FIG. 15 is a process flowchart illustrating a procedure of a method for producing dry air using an energy-saving air dryer according to yet another embodiment of the present invention.

Referring to FIG. 15, a method for producing dry air using an energy-saving air dryer according to the present invention includes the steps of: forming compressed air by compressing the air in the atmosphere (step a):

introducing the compressed air into the first adsorption tower to adsorb some of the moisture in the compressed air to produce dry air (step b);

discharging and supplying the dry air to one side, or determining whether to remove residual moisture in the dry air (step c);

introducing the dry air into the second adsorption tower to absorb residual moisture in the dry air to produce and discharge dry air (step d);

branching some of the dry air in step 2 and heat-exchanging with compressed air having compressed heat to heat the dry air (step e);

introducing the dry air heated to less than 100° C. into the first adsorption tower to regenerate the first adsorbent filled in the first adsorption tower (step f); and

branching the dry air heated in step d and forming dry air of 100 to 200° C. by heating with a heater, and introducing the formed dry air into the second adsorption tower to regenerate the second adsorbent (step g).

First, compressed air is formed by compressing the air of the atmosphere (S1000).

At this time, the compressed air has compression heat, and is used to heat and regenerate the first adsorbent and the first adsorbent by transferring the compression heat to dry air to be described below.

The compressed air is introduced into the first adsorption tower 405 to adsorb some of the moisture in the compressed air to produce dry air (S2000).

Dry air having a dew point of 2 to 10 C produced in S2000 may be supplied to one side.

The dry air is discharged and supplied to one side, or it is determined whether residual moisture in the dry air is removed (S3000).

Since the dry air may be discharged and supplied to one side, the first dry air produced through the first adsorption tower 405 may be efficiently supplied. When high-quality dry air is required, the first dry air may be introduced into the second adsorption tower in the fourth step, so that the quality of the dry air may be selected and produced.

Meanwhile, the first adsorbent has a moisture adsorption amount of 30 wt % or more to the weight of the adsorbent in a region with a relative humidity of 5 to 40% (0.05≤P/P₀≤0.5) in the adsorption isotherm, and may be regenerable to dry air at less than 100° C.

The first adsorbent may mass-produce dry air by adsorbing a large amount of moisture to the weight of the adsorbent in the range of the relative humidity. In addition, it is possible to recover and regenerate the compression heat generated when compressed air is generated, thereby saving energy and effectively producing and supplying dry air.

The dry air is introduced into the second adsorption tower to absorb residual moisture in the dry air to produce and discharge dry air (S4000);

When dry air of higher quality than the first dry air is required, the dry air may be introduced into the second adsorption tower to adsorb residual moisture in the first dry air to produce and supply the second dry air.

Dry air having a dew point of −40° C. or less may be supplied from the S4000.

The second adsorbent filled in the second adsorption tower has a moisture adsorption amount of 10 wt % or more to the weight of the adsorbent in a region with a relative humidity of 10% (P/P0≤0.1) or less according to the adsorption isotherm, and is regenerable to dry air of 100 to 200° C. or less.

Some of the dry air of S2000 is branched and the dry air is heated by exchanging heat with compressed air having compression heat (S5000).

The dry air heated to less than 100° C. is introduced into the first adsorption tower to regenerate the first adsorbent filled in the first adsorption tower (S6000).

When high-quality dry air produced in S4000 is not required, S5000 and S6000 are performed continuously immediately to S3000, and S4000 may not be performed.

Finally, the dry air heated in S4000 is branched and heated with a heater to form dry air of 100 to 200° C., and then introduced into the second adsorption tower to regenerate the second adsorbent (S7000).

Therefore, according to the energy-saving air dryer and the method for producing the dry air using the same according to the present invention, it is possible to selectively produce dry air according to the moisture content. In particular, it is possible to produce and supply dry air in large quantities by removing moisture from compressed air in a certain relative humidity range, and selectively, very effectively producing high-quality dry air for semiconductor processes or pneumatic equipment.

As described above, specific embodiments of the energy-saving air dryer and the method for producing dry air using the same according to the present invention have been described, but it is obvious that various modifications can be made without departing from the scope of the present invention. Therefore, according to the energy-saving air dryer and the method for producing the dry air using the same according to the present invention, a regeneration process of selecting an adsorbent regenerable at low temperatures, and recovering the compression heat generated during production of compressed air through heat exchange to desorb the adsorbent adsorbed with moisture is completed, thereby mass-producing high-quality dry air by reducing energy.

As described above, specific embodiments of the energy-saving air dryer and the method for producing dry air using the same according to the present invention have been described, but it is obvious that various modifications can be made without departing from the scope of the present invention.

Therefore, the scope of the present invention should not be limited to the embodiments and should be defined by the appended claims and equivalents to the appended claims.

In other words, the embodiments described above are illustrative in all aspects and should be understood as not being restrictive, and the scope of the present invention is represented by appended claims to be described below rather than the detailed description, and it is to be interpreted that the meaning and scope of the appended claims and all changed or modified forms derived from the equivalents thereof are included within the scope of the present invention.

What is claimed is:

1. An energy-saving air dryer comprising:
a compressor that compresses the air in the atmosphere to form compressed air;
a heat exchanger that is disposed on one side of the compressor and recovers the compression heat of the compressed air;
a pre-filter that is disposed on one side of the heat exchanger and removes contaminants from the compressed air;
a pair of adsorption towers which communicates with the pre-filter, and is filled with a renewable adsorbent by desorption of moisture at a lower temperature below 100° C. to adsorb moisture when the compressed air flows into by the opening and closing of valves to form dry air or receives dry air having compression heat recovered from the heat exchanger to desorb the moisture of the adsorbent; and
an after filter that extends from one side of the adsorption tower to remove contaminants from dry air from which moisture has been removed.

2. The energy-saving air dryer of claim 1, wherein the adsorbent has a moisture adsorption amount of 10 wt % or more to the weight of the adsorbent in a region of 10% relative humidity (P/P₀≤0.1) or less in the adsorption isotherm, and in which the adsorbed moisture of the adsorbent in the adsorption step is regenerated to dry air of 100° C. or less.

3. The energy-saving air dryer of claim 2, wherein the adsorbent is a metal trimesate-based metal-organic framework, a metal terephthalate-based metal-organic structure or silicoaluminophosphate-based zeolite.

4. The energy-saving air dryer of claim 1, wherein some of the dry air generated in the adsorption tower is recovered by the heat exchanger and heated by heat exchange with the compressed air having compression heat.

5. An energy-saving air dryer comprising:
a compressor that compresses the air in the atmosphere to form compressed air;
a heat exchanger that is disposed on one side of the compressor and recovers the compression heat of the compressed air;
a pre-filter that is disposed on one side of the heat exchanger and removes impurities from the compressed air;
a cooling dryer that is disposed around the pre-filter and configured to discharge condensed water by condensing moisture in the compressed air by cooling the compressed air by introducing a coolant to one side;
a pair of adsorption towers which is connected to the cooling dryer, and is filled with a renewable adsorbent by desorption of moisture at a lower temperature below 100° C. to adsorb moisture when the compressed air flows into by the opening and closing of valves to form dry air or receives dry air having compression heat recovered from the heat exchanger to desorb the moisture of the adsorbent; and
an after filter that extends from one side of the adsorption tower to remove the impurities from dry air from which moisture has been removed.

6. The energy-saving air dryer of claim 5, wherein the adsorbent has a moisture adsorption amount of 10 wt % or more to the weight of the adsorbent in a region of 10% relative humidity (P/P₀≤0.1) or less in the adsorption isotherm, and in which the adsorbed moisture of the adsorbent in the adsorption step is regenerated to dry air of 100° C. or less.

7. The energy-saving air dryer of claim 6, wherein the adsorbent is a metal trimesate-based metal-organic framework, a metal terephthalate-based metal-organic structure or silicoaluminophosphate-based zeolite.

8. The energy-saving air dryer of claim 5, wherein the heat exchanger recovers the compression heat generated in the process of forming compressed air by compressing the air in the atmosphere by the compressor and transfers the compression heat to the dry air.

9. The energy-saving air dryer of claim 5, wherein some of the dry air generated in the adsorption tower is recovered by the heat exchanger and heated by heat exchange with the compressed air having compression heat.

10. The energy-saving air dryer of claim 5, wherein the cooling dryer is introduced with a coolant to one side to cool the dry air to 4 to 6° C., and to collect and discharge moisture in the dry air as condensed water.

11. The energy-saving air dryer of claim 5, wherein the adsorption tower absorbs 1 to 30 wt % of moisture to the total moisture adsorption amount in the introduced compressed air to discharge dry air.

12. A method for producing dry air comprising:
forming compressed air by compressing the air in the atmosphere (step 1):
preliminary-cooling the compressed air by heat exchange (step 2);
introducing the compressed air into a cooling dryer and forming and discharging condensed water by exchanging heat with a coolant to remove some moisture from the compressed air (step 3);
producing dry air by contacting the compressed air from which some of the moisture has been removed with a renewable adsorbent by desorption of moisture at a lower temperature below 100° C. (step 4);
heating the dry air by bypassing some of the dry air and exchanging heat with compressed air having compression heat (step 5); and
desorbing moisture by contacting the heated dry air with the adsorbent to which moisture has been adsorbed (step 6).

13. The method for producing dry air of claim 12, wherein in step 4, the adsorbent has a moisture adsorption amount of 10 wt % or more to the weight of the adsorbent in a region of 10% relative humidity (P/P₀≤0.1) or less in the adsorption isotherm, and is a metal trimesate-based metal-organic framework, a metal terephthalate-based metal-organic structure or silicoaluminophosphate-based zeolite, in which the adsorbed moisture of the adsorbent in the adsorption step is regenerated to dry air of 100° C. or less.

14. An energy-saving air dryer comprising:
a compressor that compresses the air in the atmosphere to form compressed air;
a heat exchanger that is disposed on one side of the compressor and recovers the compression heat of the compressed air;
a pre-filter that is disposed on one side of the heat exchanger and removes impurities from the compressed air;
a first adsorption tower that is disposed on one side of the pre-filter and filled with a renewable first adsorbent by desorption of moisture at a lower temperature below 100° C. and introduces compressed air by opening and closing of valves and adsorbs moisture in the compressed air to produce dry air; and
a second adsorption tower that is disposed on one side of the first adsorption tower, filled with a second adsorbent and introduces dry air discharged from the first adsorption tower, absorbs moisture remaining in the dry air.

15. The energy-saving air dryer of claim 14, wherein the first adsorbent has a moisture adsorption amount of 30 wt % or more to the weight of the adsorbent in a region with a relative humidity of 5 to 40% (0.05≤P/P₀≤0.5) in the adsorption isotherm, and is regenerable to dry air at less than 100° C.

16. The energy-saving air dryer of claim 14, wherein the second adsorbent has a moisture adsorption amount of 10 wt % or more to the weight of the adsorbent in a region of 10% relative humidity (P/P₀≤0.1) or less in the adsorption isotherm.

17. The energy-saving air dryer of claim 14, wherein the first adsorption tower and the second adsorption tower are arranged in series through a first dry air introduction path.

18. The energy-saving air dryer of claim 14, wherein one side of the first adsorption tower is provided with a first dry air discharge valve, and discharges dry air having a dew point of 2° C. to 10° C. through the first dry air discharge valve.

19. The energy-saving air dryer of claim 14, wherein some of the dry air produced in the first or second adsorption tower is branched and introduced into the heat exchanger, heated by heat exchange with the compression heat and recovered to one side of the first or second adsorption tower, and desorbs moisture adsorbed on the adsorbent by heating the first or second adsorbent.

20. The energy-saving air dryer of claim 14, wherein the compression heat is maintained below 100° C., the compression heat heats the dry air introduced into the heat exchanger, and the heated dry air flows into one side of the first adsorption tower to desorb moisture adsorbed on the first adsorbent and regenerate the first adsorbent.

21. The energy-saving air dryer of claim 14, wherein some of the dry air produced in the second adsorption tower is branched and recovered by the heat exchanger, and the dry air is heated by heat exchange in the heat exchanger, reheated through a heater provided at one side of the heat exchanger, and introduced to the one side of the second adsorption tower to regenerate the second adsorbent.

22. A method for producing dry air comprising:
forming compressed air by compressing the air in the atmosphere (step a):
introducing the compressed air into the first adsorption tower to adsorb some of the moisture in the compressed air to produce dry air (step b);
discharging and supplying the dry air to one side, or determining whether to remove residual moisture in the dry air (step c);
introducing the dry air into the second adsorption tower to absorb residual moisture in the dry air to produce and discharge dry air (step d);
branching some of the dry air in step b and heat-exchanging with compressed air having compressed heat to heat the dry air (step e);
introducing the dry air heated to less than 100° C. into the first adsorption tower to regenerate the renewable first adsorbent by desorption of moisture at a lower temperature below 100° C. (step f); and
branching the dry air heated in step d and forming dry air of 100 to 200° C. by heating with a heater, and introducing the formed dry air into the second adsorption tower to regenerate the second adsorbent (step g).

23. The energy-saving air dryer of claim 22, wherein the first adsorbent has a moisture adsorption amount of 30 wt % or more to the weight of the adsorbent in a region with a relative humidity of 5 to 40% (0.05≤P/P₀≤0.5) in the adsorption isotherm, and is regenerable to dry air at less than 100° C., and
the second adsorbent has a moisture adsorption amount of 10 wt % or more to the weight of the adsorbent in a region of 10% relative humidity (P/P₀≤0.1) or less in the adsorption isotherm and is regenerable to dry air at 100° C. to 200° C. or less.

24. The energy-saving air dryer of claim 22, wherein in step (b), the produced dry air with a dew point of 2 to 10° C. is discharged to one side.

25. The energy-saving air dryer of claim 22, wherein in step d, dry air with a dew point of −40° C. or less is supplied.
